(19) United States
(12) Patent Application Publication
(10) Pub. No.: US 2026/0186742 A1
(43) Pub. Date: Jul. 2, 2026

(54) RESOLVING DYNAMIC KEY-VALUE CACHE PERCEIVED NON-DETERMINISM

(71) Applicant: Groq, Inc., San Jose, CA (US)

(72) Inventor: Roberto DiCecco, Toronto (CA)

(21) Appl. No.: 19/433,474

(22) Filed: Dec. 26, 2025

Related U.S. Application Data
(60) Provisional application No. 63/738,918, filed on Dec. 26, 2024.

(51) Int. Cl. G06F 7/523

(52) U.S. Cl. CPC G06F 7/523

(57) ABSTRACT

Methods and systems for dynamic key-value cache management are provided. In one example, a method of processing key-value blocks (KV blocks) in a processor system includes providing a cyclic distribution of elements for a plurality of KV blocks associated with a key-value cache, the cyclic distribution providing a subset of elements of each of the plurality of KV blocks in one or more registers. In some implementations, the example method of processing key-value blocks (KV blocks) in a processor system includes accumulating a plurality of partial multiplication results to provide an output in a lossless numerical representation based at least in part on the cyclic distribution of the plurality of KV blocks.

### CROSS REFERENCE TO PRIORITY APPLICATION

The present disclosure claims the benefit of priority to U.S. Provisional Patent Ser. No. 63/738,918, titled “RESOLVING DYNAMIC KEY-VALUE CACHE PERCEIVED NON-DETERMINISM,” filed Dec. 26, 2024, the entirety of which is incorporated by reference herein.

### FIELD

The present disclosure relates generally to resolving dynamic key-value cache perceived non-determinism.

### BACKGROUND

A tensor is a family of mathematical structures that includes vectors, matrices and higher dimensional arrays. Tensors are used in many fields of science and engineering, and huge tensors with millions to billions of elements are used in numerical calculations such as machine learning. Tensor operations such as multiplication require huge amounts of processing power for large tensors. Specialized processors for processing tensors have been developed in recent years. Example tensor processors may comprise a two-dimensional array of functional units (e.g., tiles) organized into a plurality of functional units. Each functional unit is configured to perform specific functions within the processor. Data may flow across the functional units in a first dimension across lanes. Instructions may flow across functional units in a second dimension across the processor.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of performing floating point operations utilizing a plurality of key-value (KV) blocks of a KV cache in a processor. The method includes providing a first element of a first KV block of the plurality of KV blocks to a data vector associated with a token generation operation. The method further includes providing a first element of a second KV block of the plurality of KV blocks to the data vector according to a cyclic distribution of the plurality of KV blocks. The method also includes accumulating a plurality of partial multiplication results utilizing the first element of the first KV block and the first element of the second KV block in a lossless numerical representation based at least in part on the cyclic distribution of the plurality of KV blocks.

Another example aspect of the present disclosure is directed to a processor configured to perform operations. The operations include providing a first element of a first KV block of a plurality of KV blocks to a data vector associated with a token generation operation. The operations further include providing a first element of a second KV block of the plurality of KV blocks to the data vector according to a cyclic distribution of the plurality of KV blocks. The operations also include accumulating a plurality of partial multiplication results utilizing the first element of the first KV block and the first element of the second KV block in a lossless numerical representation based at least in part on the cyclic distribution of the plurality of KV blocks.

Yet another example aspect of the present disclosure is directed to one or more non-transitory computer-readable media storing instructions that, when executed, cause a processor device to perform operations. The operations include providing a first element of a first KV block of a plurality of KV blocks to a data vector associated with a token generation operation. The operations further include providing a first element of a second KV block of the plurality of KV blocks to the data vector according to a cyclic distribution of the plurality of KV blocks. The operations also include accumulating a plurality of partial multiplication results utilizing the first element of the first KV block and the first element of the second KV block in a lossless numerical representation based at least in part on the cyclic distribution of the plurality of KV blocks.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 is a block diagram of an example processor device according to example aspects of the present disclosure.

FIG. 2 is a block diagram of an example processor device according to example aspects of the present disclosure.

FIG. 3 is a block diagram of an example multimodal multiplier circuit according to example aspects of the present disclosure.

FIG. 4 is a block diagram of an example multimodal multiplier circuit according to example aspects of the present disclosure.

FIG. 5 is a block diagram of an example multimodal multiplier circuit according to example aspects of the present disclosure.

FIG. 6 is a block diagram of an example multimodal multiplier circuit according to example aspects of the present disclosure.

FIG. 7 is a block diagram of an example multimodal multiplier circuit according to example aspects of the present disclosure.

FIG. 8 is a block diagram of an example multimodal multiplier circuit according to example aspects of the present disclosure.

FIG. 9 depicts a diagram illustrating dynamic KV cache management with perceived non-determinism.

FIG. 10 depicts example cyclic distribution of blocks according to example aspects of the present disclosure.

FIG. 11 depicts a flowchart diagram of a method according to example aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Example implementations according to some aspects of the present disclosure are directed to systems and methods for resolving dynamic key-value cache perceived non-determinism in deterministic tensor processors used in computing operations involving significant amounts of tensor processing, such as, for example, execution of machine-learned models. Machine-learned models such as large language models (LLMs) can be used in generative artificial intelligence applications for a variety of purposes, such as for programming assistants, chatbots, and a variety of other applications. Specialized tensor processors, referred to as language processing units or “LPUs” (which may also be referred to as “tensor streaming processors” or “TSPs”), can provide efficient computation of tensor operations that comprise significant portions of the computing operations involved in utilizing machine-learned models.

Some LLMs, such as transformer models, may operate by generating words or “tokens” based on a prompt or query from a user or another system, which may generally be descriptive of a task or problem to be solved by the LLM. The prompt or query can be used as “context” for the LLM, seeding the generation of new tokens from the information contained in the prompt or query. Additionally and/or alternatively, previously-generated tokens can be appended to the context in the generation of a present token (or tokens), with this process iterating over one or more iterations until an output of the LLM is complete. During inference, many transformer models can process input data sequentially, generating output tokens one at a time (or in a batch of one or more tokens at a time).

Many LLMs, such as transformer models, can benefit from the use of a key-value (KV) cache to avoid redundant computations by storing the intermediate results of a mechanism, such as a self-attention mechanism (e.g., key and value vectors), computed during the forward pass for each processed input token. When generating subsequent tokens, the model can retrieve and reuse these cached key-value pairs from the KV cache. This can provide for the LLM to compute the self-attention for new tokens without requiring that the LLM recalculate the key and value vectors for previous tokens at each iteration. This, in turn, can provide a significantly lower latency and/or computing resource expenditure compared to recomputing the key and value vectors for each subsequent iteration.

Furthermore, the throughput of LLMs may be improved by batching requests, such that multiple input sequences can be processed in parallel. This approach, while improving efficiency, can involve efficient memory management techniques to avoid overwhelming the memory resources available to a computing system implementing the LLM. For instance, a significant portion of the memory space utilized in batch processing can be attributable to the KV cache, and inefficient KV cache management can quickly limit the batch size and/or throughput, and consequently the efficiency, of an LLM.

For instance, in some implementations, a standard-size KV cache allocation can be provided for each input. This approach, however, presents various challenges. First, because the allocation is statically sized, the same allocation is provided for a relatively short context (e.g., an input of only a few tokens) and a longer context (e.g., an input of several hundred or thousand tokens), leading to memory wastage associated with shorter contexts. Furthermore, this approach can lead to fragmentation of the KV cache as KV cache allocations are deallocated while subsequent portions of memory are still allocated, which can result in increased latency when traversing the KV cache.

Dynamic approaches to KV cache management can improve efficiency of KV cache access and, consequently, LLMs. One example approach for dynamic KV cache management is referred to as “PagedAttention” as described in Kwon et al., “Efficient Memory Management for Large Language Model Serving with PagedAttention,” arXiv:2309.06180 (September 12, 2023). In some example methods for dynamic KV cache management, continuous key and value vectors may be stored in non-contiguous blocks in the KV cache memory. Each block can provide storage of a fixed number of tokens, which is referred to as KV block size. During processing of an input, a KV cache manager may identify and fetch different KV blocks separately for processing. In this manner, a context for a particular input may be divided among several non-contiguous blocks in the KV cache, which can provide for smaller initial allocations and dynamic resizing as context grows, thereby reducing memory wastage. As one example, a processor may be configured to multiply a query vector by key vectors in a KV block to obtain an attention score and then later multiply the attention score by the value vectors in a second KV block to obtain an attention output.

This approach can be beneficial for memory management efficiency. However, in the case where this approach is utilized with deterministic tensor processors with accumulators, the dynamic assignment of KV cache blocks to requests, which can be dependent on the present memory availability of the KV cache and may therefore not be predicted deterministically, can lead to different KV cache blocks being allocated to otherwise identical requests, presenting a non-deterministic factor that can frustrate deterministic operation. For example, the allocation of KV cache blocks from memory at varying locations on a tensor processor can cause partial results of tensor operations to be accumulated in different accumulation registers from request to request. In addition, the partial results of tensor operations may be accumulated in different order, as the ordering may be dependent on the position within the accumulation registers. Furthermore, as the accumulation registers may be associated with different numerical representations, which may not necessarily be lossless and/or may not be associative, the accumulation order differences can produce a perceived non-deterministic aspect when implementing dynamic KV cache management due at least in part to the lack of associativity of non-lossless numerical representations, such as floating point representations (e.g., FP32, FP16). This non-deterministic aspect can present undesirable variations between operations of a deterministic processor, which should ideally produce identical outputs when identical deterministic operations are performed.

Example aspects of the present disclosure resolve this perceived non-determinism by decoupling the physical location of the KV cache blocks from the logical order in which they are processed and accumulated. In some implementations, the system maintains a logical mapping of the KV blocks that dictates a deterministic accumulation order for partial results, regardless of the non-contiguous physical addresses from which the blocks are fetched. For example, when a tensor processor performs attention calculations across multiple dynamically allocated blocks, the processor (or a controlling compiler/scheduler) can provide that the partial attention scores are summed in an order corresponding to the logical token sequence rather than the physical memory offset. This can provide for the processor to retain the memory efficiency benefits of dynamic, non-contiguous allocation (e.g., PagedAttention) while ensuring that the floating-point accumulation sequence remains identical across repeated inference runs, thereby preserving bitwise determinism.

For instance, according to example aspects of the present disclosure, dynamic KV cache management can be implemented using a cyclic distribution of KV blocks so that individual elements of different KV blocks may be provided within the same vector, allowing for accumulation and representation of partial results in a lossless and associative numerical representation, such as an extended fixed-point numerical representation. This extended fixed-point numerical representation can provide for storing a greater number of bits of precision (e.g., on the order of 100 bits of precision) for intermediate operations such as accumulation to provide lossless operations, such as accumulation, regardless of input bit width. The number of bits in the extended fixed-point numerical representation can be greater than the bit length of a longest input to an accumulator, such as between 1 to 2 times the bit length of the longest input. The lossless and associative numerical representation reduces perceived non-determinism that may result from different accumulation orders of partial results in a non-lossless format, such as floating point numerical representation.

As used herein, a key-value (KV) cache allocation refers to the memory space reserved within a KV cache to store the intermediate key and value vectors generated by a machine-learned model (e.g., an LLM) during inference for a single task/user, allowing the model to reuse these computations for subsequent token generation. In dynamic management schemes, this allocation is divided into KV blocks, which are non-contiguous memory units that each store key and value vectors for a fixed number of tokens, providing for the system to resize memory usage dynamically as context grows. An “element” of a KV block represents the granular unit of data within these blocks, such as a specific numerical value corresponding to a key or value vector dimension, or the amount of memory utilized by the KV cache for data associated with a single token, which can be individually accessed and interleaved into processor registers (e.g., via cyclic distribution) to enable deterministic accumulation of partial results, according to aspects of the present disclosure.

For instance, dynamic KV cache management is implemented using any suitable cyclic distribution (e.g., striping or interleaving) of KV blocks. This can provide that, while the KV blocks may be stored in non-contiguous physical memory locations (e.g., different pages), individual elements of each KV block can be fetched and packed into processing vectors in a consistent, interleaved pattern. This distribution facilitates the accumulation and representation of partial results in a lossless and associative numerical representation, such as an extended fixed-point numerical representation. By utilizing a lossless format, the system can mitigate the non-associativity inherent in standard floating-point arithmetic (e.g., where (A+B)+C is not necessarily equal to A+(B+C) due to intermediate rounding of floating point arithmetic sub-operations). Consequently, this approach reduces or eliminates the perceived non-determinism that typically results when partial results from dynamically allocated memory blocks are accumulated in varying orders using non-lossless formats (e.g., standard FP16 or BF16).

For instance, a method of processing KV blocks in a processor system may include providing a cyclic distribution of elements for a plurality of KV blocks associated with a key-value cache. Rather than filling a vector register with contiguous elements from a single block (e.g., [BlockA_0, BlockA_1, BlockA_2, BlockA_3]), the cyclic distribution provides a subset of elements from multiple different KV blocks within the same vector register or across a set of registers associated with the same time step. For example, a single vector may contain the first element of four different blocks (e.g., [BlockA_0, BlockB_0, BlockC_0, BlockD_0]), rather than greedily-allocated elements of blocks, such as contiguous elements of any given block. The method provides for accumulating a plurality of partial multiplication results derived from these interleaved vectors to provide an output in a lossless numerical representation. This provides that even if Block A and Block B are physically located in different memory banks due to dynamic paging, respective contributions to the final attention score from elements of Block A and Block B can be accumulated without precision loss, rendering the specific processing order irrelevant to the final numerical result. The elements may be assigned in cyclic ordering from different KV blocks (e.g., a first element from one KV block, a second element from a sequential KV block, and so on until the final KV block of a KV cache allocation is reached, at which point the next assigned element will come from the first KV block in the KV cache allocation).

In some example aspects, the cyclic distribution is configured to align corresponding elements across blocks. For example, the system may provide a first element of a first KV block (e.g., Key vector K1 from Block A) and a first element of a second KV block (e.g., Key vector K1 from Block B) into one or more registers associated with a first vector operation. This generates at least one first set of partial results (e.g., partial attention scores for the first token position in each block). Subsequently (or in parallel), the cyclic distribution provides a second element of the first KV block and a second element of the second KV block in one or more registers associated with a second vector to generate a second set of partial results. These registers may be located on the same processor functional group or distributed across different processor functional groups (e.g., different lanes in a Superlane) depending on the width of the cyclic stride, yet they contribute to the same global accumulation context.

In some examples, the resulting partial results (e.g., the dot products of the queries and the interleaved keys) are accumulated using a lossless numerical format, such as an extended fixed-point lossless numerical representation. The use of an extended fixed-point representation allows partial results to be summed in any order, based on the dynamic availability of the KV blocks, while yielding a bitwise identical final result. In this way, KV blocks may be processed as part of a high-throughput dynamic KV cache management system (e.g., PagedAttention) in a manner that is both mathematically associative and computationally deterministic, resolving the conflict between flexible memory management and deterministic output requirements.

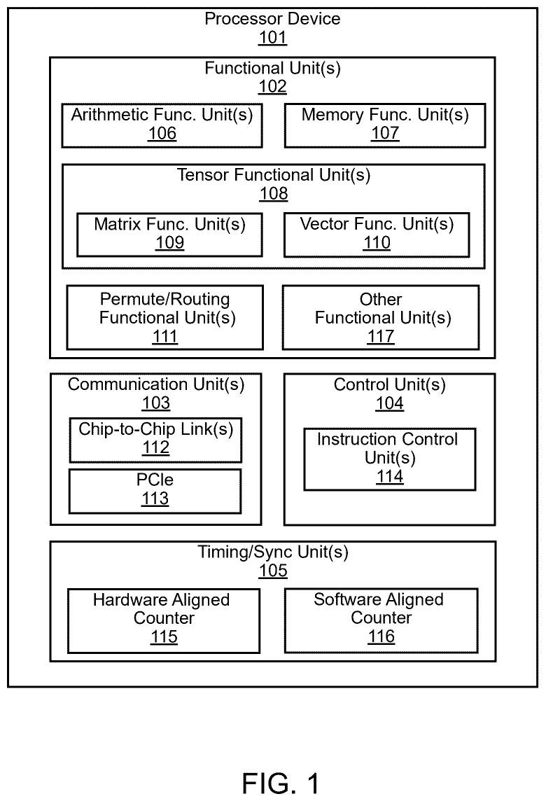

FIG. 1 is a block diagram of an example processor device 101 according to example implementations of aspects of the present disclosure. The processor device 101 can include one or more functional units 102; one or more communication units 103; one or more control units 104 (e.g., instruction control unit(s) 114, etc.); one or more timing or synchronization units 105; or other components. In some instances, functional unit(s) 102 of the processor device 101 can include one or more of: arithmetic functional unit(s) 106; memory functional unit(s) 107; tensor functional unit(s) 108 (e.g., matrix functional unit(s) 109, vector functional unit(s) 110, etc.), permute or routing functional units 111, or other functional units 117. Communication unit(s) 103 can include, for example, one or more of chip-to-chip communication link(s) 112, peripheral component interconnect express 113 components, or other communication unit(s) 103. Timing and synchronization units 105 can include, for example, one or more hardware-aligned counters 115, one or more software-aligned counters 116, or other timing or synchronization component.

A processor device 101 can include various types of processor architectures. In some instances, a processor device 101 can include a single-core or multi-core processor device 101. In some instances, a processor device 101 can include an integrated circuit located on a single die or a processor device 101 distributed over multiple dies connected together (e.g., directly connected such as via face-to-face connection, indirectly connected such as via one or more interposers, etc.). In some instances, a processor device 101 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 101 can include a deterministic processor device or a non-deterministic processor device (e.g., processor device configured to operate according to a deterministic or non-deterministic timing, etc.). In some instances, a processor device 101 can include a processor device having a plurality of dedicated special-purpose functional units, or a processor device having one or more general-purpose functional units (e.g., multi-core processor having a plurality of general-purpose processor cores, etc.). For example, in some instances, a processor device 101 can include a single-core processor device 101 having a plurality of special-purpose functional units 102 having distinct functions, such as functional units 102 having distinct instruction set architectures.

In some instances, a processor device 101 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 102 or other component of a processor device 101 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 102, communication unit(s) 103, etc.) having an instruction set architecture comprising instructions to control a timing of one or more operations of the one or more components.

In some instances, a deterministic processor device 101 can include a processor device configured to route data between functional units 102 of the processor device 101 according to a predetermined timing, predetermined routing or pathing, or both. For example, in some instances, a deterministic processor device 101 can include a processor device configured to receive compiled instructions comprising data indicative of one or more data transfer operations to be performed according to one or more predetermined routes determined by a compiler, according to one or more predetermined timing values defined by the compiler, or both. In this manner, for instance, a deterministic processor device 101 can enable a compiler to perform compile-time load balancing for a plurality of data paths, and can execute a plurality of runtime data transfers according to the compile-time load balancing.

In some instances, a deterministic processor device 101 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 101 can lack any branch prediction components, and can be configured to execute every operation of a compiled program according to a predetermined program order. As another example, in some instances, one or more memory functional units 107 can lack a cache hierarchy or lack any non-deterministic memory component(s). For example, in some instances, one or more memory functional units 107 can be configured to operate deterministically, such as according to a predetermined timing defined by a compiler. For example, in some instances, one or more memory functional units 107 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 107; or the like. For example, in some instances, the compiler can compile a program or other executable into a set of deterministic operations that can be executed by the functional unit(s) 102 at known times specified by a deterministic schedule.

However, although a deterministic processor device 101 can lack some common sources of non-determinism, in some instances, a deterministic processor device 101 can include or interact with one or more non-deterministic components or devices without deviating from the scope of the present disclosure. As a non-limiting illustrative example, in some instances, a deterministic processor device 101 can include a PCIe 113 component configured to perform external input/output (I/O) operations, which can in some instances include input/output operations having a non-deterministic timing (e.g., I/O operations using a non-deterministic PCIe 113 device; I/O operations receiving input from non-deterministic external device(s); etc.). In some instances, a deterministic processor device 101 can interact with non-deterministic component(s) or device(s) (e.g. components or devices internal or external to the processor, etc.), while maintaining deterministic operation of the remaining components of the processor device 101 by designating one or more predetermined time windows to interact with the non-deterministic component(s) in a deterministic manner. For example, in some instances, a processor device 101 can be configured to check, at each of a plurality of predetermined times, whether one or more inputs (e.g., inference request(s), etc.) has been received via a PCIe device 113; and, if the processor device 101 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 101 can include a processor device configured for single-instruction multiple-data (SIMD) operation. For example, in some instances, a processor device 101 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 102 (e.g., adjacent functional units 102 arranged in a functional region, etc.) to cause each respective functional unit 102 of the plurality of functional units 102 to execute the instruction on one or more distinct operands provided to the respective functional unit 102 (e.g., routed to the respective functional unit 102 according to a predetermined compiler-defined routing, etc.).

In some instances, a processor device 101 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 102, a set of operations defined by the single set of instructions. For example, in some instances, a single-core processor device 101 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 102, the plurality of operations (e.g., SIMD operations wherein each operation is a multiple-data operation, etc.) on the one or more operands.

Functional unit(s) 102 can include, for example, one or more components (e.g., integrated circuit components, etc.) configured to perform operations on one or more operands (e.g., data operands, etc.). In some instances, functional unit(s) 102 can include deterministic functional units 102, such as deterministic functional units configured to perform one or more operations in a predetermined program order, according to a predetermined timing or temporal relationship, or the like. In some instances, a set of functional units 102 can include a plurality of dedicated or special-purpose functional units 102, such as distinct functional units 102 having distinct functions or sets of functions (e.g., limited or specialized function sets, etc.). In some instances, functional unit(s) 102 can include functional units configured to perform multiple operations per instruction for at least some instructions, such as single-instruction multiple-data (SIMD) functional unit(s) 102, and/or functional unit(s) 102 configured to process instruction(s) directed to multiple computing operations (e.g., multiple repetitions of a single type of operation, pipeline of multiple different operations, etc.).

In some instances, a set of dedicated functional unit(s) 102 can include distinct dedicated functional units 102 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 102 for implementing a fully connected layer of a machine-learned model can include one or more matrix functional units 109 for performing matrix multiplication between a parameter tensor (e.g., weight matrix, etc.) and a tensor (e.g., vector, etc.) of input values to the fully connected layer, and one or more vector functional units 110 for performing an activation function of the fully connected layer. As another example, in some instances, a set of dedicated functional units 102 for implementing a convolutional layer of a machine-learned model can include one or more permute/routing functional units 111 configured to perform one or more data reshaping operations corresponding to one or more convolutions (e.g., two-dimensional convolutions, one-dimensional convolutions, etc.); and one or more other functional units 102 (e.g., matrix functional unit(s) 109, vector functional unit(s) 110, etc.) for performing additional operations associated with a convolutional layer or convolutional neural network (e.g., matrix multiplication, pooling, activation functions, etc.).

In some instances, a plurality of dedicated functional units 102 can include a first functional unit 102 configured to perform a set of operations that is different (e.g., completely disjoint from or partially overlapping, etc.) from a second set of operations associated with a second functional unit 102. In some instances, a plurality of special-purpose or dedicated functional units 102 can have a plurality of distinct instruction set architectures, such as limited or special-purpose instruction set architectures each supporting a limited or special-purpose set of operations. As a non-limiting illustrative example, in some instances, a set of dedicated functional units 102 can include one or more of: a matrix functional unit 109 configured to perform a first set of matrix operations (e.g., matrix multiplication operations, etc.); a vector functional unit 110 configured to perform a set of vector operations different from the matrix operations (e.g., activation function operations such as rectified linear unit (ReLU), sigmoidal, softmax, or other activation function operations; normalization operations; etc.); a permute/routing functional unit 111 configured to perform one or more data routing, data permutation, or data reshaping functions (e.g., tensor permutation or reshaping, etc.) different from the matrix operation(s) and different from the vector operation(s); or other dedicated functional unit(s) 102. Other examples are possible.

In some instances, functional unit(s) 102 can include functional units organized into functional regions of a processor die, such as compact functional regions configured to facilitate low-latency propagation of instructions or operands within a functional unit 102 or between adjacent functional units 102. As a non-limiting illustrative example, in some instances, one or more functional units 102 can be organized into functional groups (or “slices”) along a first axis of a processor die, thereby enabling low-latency propagation of one or more instructions along the axis, low-latency propagation of operand data along a second axis, or the like.

In some instances, functional unit(s) 102 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 102 or functional regions of a processor device 101 for performing a sequentially first operation in a computational pipeline can be geographically close to one or more functional units 102 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 102 can include functional units configured to perform multiple operations per instruction for at least some instructions, such as single-instruction multiple-data (SIMD) functional unit(s) 102 or functional units 102 configured to operate without necessarily receiving explicit instructions for each operation. For example, functional unit(s) 102 configured to operate without necessarily receiving explicit instructions for each operation can include one or more of: functional unit(s) 102 configured to receive intermittent instructions and perform multiple operations per instruction (e.g., repeated single operation, pipeline of multiple different operations, etc.); functional unit(s) 102 configured to operate without instructions according to a default operation; or the like. In this manner, for instance, an amount of communication required to provide instructions to the functional units 102 can be reduced, and operation of the processor device 101 can in some instances be simplified compared to some alternative implementations.

For example, in some instances, a SIMD functional unit 102 can include a tensor functional unit 108 configured to execute an instruction on a plurality of numerical values, such as a vector or matrix of numerical values. For example, in some instances, a tensor functional unit 108 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples). In some instances, a tensor functional unit 108 can be configured to process some or all of a plurality of values simultaneously, or to execute a single-instruction multiple-data instruction according to a staggered timing.

As another example, in some instances, a functional unit 102 configured to operate based on intermittent instructions can include a functional unit 102 configured to repeat one or more operations, such as a functional unit 102 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 102 can include a functional unit 102 configured to receive and execute one or more repetition instructions (e.g., having an instruction set architecture comprising one or more repetition instructions, etc.). A repetition instruction can include, for example, an instruction to cause the functional unit 102 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 102 location, memory location, data path location, etc.) associated with a repeated operation, or other offset parameter.

As another example, in some instances, a functional unit 102 can include a functional unit 102 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 102 can include a pipelined hardware architecture (e.g., systolic array pipelined hardware, deterministic streaming hardware, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 102 can include a geographically compact architecture, wherein a plurality of components for performing a multi-operation instruction can be adjacent or otherwise close together on a processor die.

An arithmetic functional unit 106 can include, for example, one or more functional units 102 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 106 can be a tensor functional unit 108 or component thereof, or have one or more properties described below with respect to tensor functional unit(s) 108.

A memory functional unit 107 can include, for example, one or more functional units 102 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 107 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

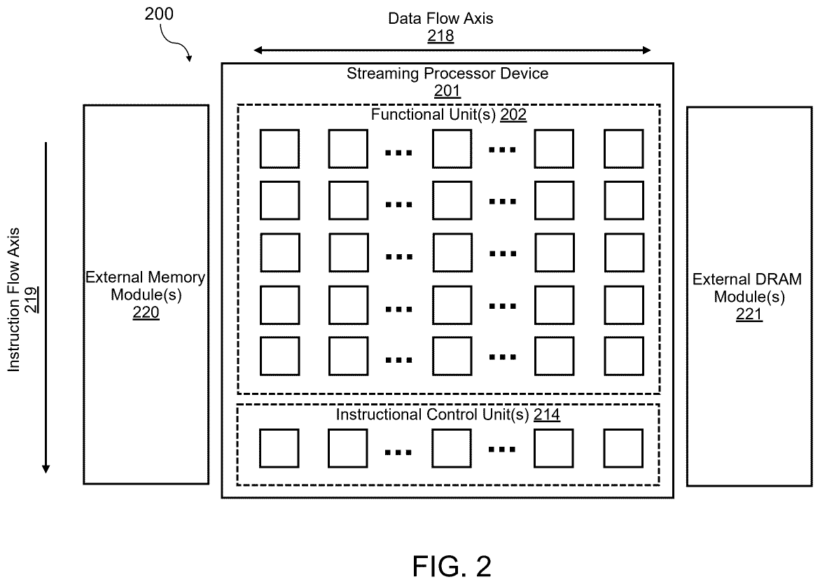

In some instances, one or more memory functional units 107 can be configured to share a global address space accessible to a plurality of functional units 102. For example, in some instances, a global address space can include all memory locations available to the processor device 101 (e.g., including any external memory modules, etc.), such that any functional unit 102 of the processor device 101 can obtain (e.g., receive at a predetermined time defined by the compiler, such as without requiring the functional unit 102 to output any request for the data obtained). In some instances, a set of memory functional unit(s) 107 can include, or a processor device 101 can have access to, one or more internal (e.g., on-chip) memory functional units 107; one or more external (e.g., off-chip, near-compute, etc.) memory units; or both. Further details of some example near-compute external memory units are provided below with respect to FIG. 2.

A tensor processing unit 108 can include, for example, a functional unit 102 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 108 can include a matrix functional unit 109; a vector functional unit 110; or another functional unit.

A matrix processing unit 109 can include, for example, a functional unit 102 configured to perform one or more operations on a matrix (e.g., two-dimensional matrix, flattened matrix, etc.) of operands (e.g., numerical values such as floating-point values, etc.). In some instances, a matrix processing unit 109 can include a functional unit 102 configured to perform matrix multiplication or other matrix operations.

A vector processing unit 110 can include, for example, a functional unit 102 configured to perform one or more operations on a vector (e.g., one-dimensional vector, flattened tensor, etc.) of operands (e.g., floating-point numerical values, etc.). In some instances, a vector processing unit 110 can include a functional unit 102 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 111 can include, for example, a functional unit 102 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 107; a tensor, matrix, or vector functional unit 108, 109, 110; or a permute/routing functional unit 111 can be or include a deterministic functional unit 102 configured to execute instruction(s) at a predetermined time defined by a compiler; a single-instruction multiple-operation functional unit 102 configured to perform a plurality of operations based on one instruction; or have any other property described herein with respect to functional unit(s) 102.

Communication units 103 can include various components for performing communication operations (e.g., input, output, etc.) between the processor device 101 and other devices (e.g., processor devices, computing devices, external memory devices, etc.) or components, or within the processor device 101. In some instances, communication units 103 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 101 can include a plurality of deterministic chip-to-chip communication links 112 configured to communicate with other deterministic processor devices 101 (e.g., using deterministic communication operations having a predetermined timing, communication path, or other property), along with one or more PCIe components 113 configured to interact with one or more non-deterministic components. In some instances, communication units 103 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 101 such as routers, repeaters, switches, panels, or the like); or other components configured to facilitate one or more communication operations.

Chip-to-chip communication units 112 can include, for example, any device or component for communicating with another processor device (e.g., processor device 101, etc.), such as one or more serializer-deserializer units, one or more communication channels (e.g., signal lines, etc.), one or more connection components (e.g., ports, pins, connection pads, etc.), or the like. In some instances, a processor 101 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 101. In some instances, chip-to-chip communication units 112 can include units configured to communicate with processor devices that are geographically close to or far away from the processor device 101 (e.g., in a same or different compute node as the processor device 101; in a same or different rack; etc.). In some instances, chip-to-chip communication units 112 can include connections to a plurality of distinct chips, a plurality of connections to a single chip, or both. In some instances, chip-to-chip communication units 112 can include chip-to-chip communication units 112 associated with one or more bidirectional communication channels, one or more unidirectional communication channels, or both. In some instances, chip-to-chip communication units 112 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 105 can be used to provide synchronization for one or more processor devices 101 to facilitate deterministic-timing communication between chips.

A peripheral component interconnect express (PCIe) component 113 can include, for example, a communication device configured to facilitate communication between a processor device 101 and one or more other devices (e.g., computing devices; processor devices; data storage devices; auxiliary devices; etc.). In some instances, a PCIe unit 113 can include a communication system conforming to one or more PCIe communication standards (e.g., PCIe 6.0, PCIe 7.0, etc.). Although FIG. 1 depicts a PCIe unit 113, other communication units or communication standards can be used without deviating from the scope of the present disclosure. In some instances, a processor device 101 can include a deterministic processor device 101 configured to communicate non-deterministically via the PCIe unit 113 while maintaining determinism in the functional unit(s) 102 of the processor device 101 (e.g., according to methods described above).

In some instances, control unit(s) 104 can include one or more devices for controlling one or more operations of the functional unit(s) 102, such as device(s) configured to supply one or more control signals (e.g., assembly code or machine code instructions; switching signals, multiplexer selection signals, etc.) to one or more functional unit(s) 102.

In some instances, control unit(s) 104 can include one or more instruction control unit(s) 114 configured to supply computer-executable instruction(s) to one or more functional units. In some instances, an instruction control unit 114 can include a deterministic instruction control unit 114 configured to supply instruction(s) to the functional unit(s) 102 according to a predefined program order determined by the compiler; supply instruction(s) at one or more predefined times (e.g., clock cycles, etc.); or the like. In some instances, an instruction control unit 114 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 102 at a second time (e.g., second time predetermined by the compiler, etc.)

In some instances, instruction(s) provided to a functional unit 102 by an instruction control unit 114 can be the same as or different from a corresponding instruction received by the instruction control unit 114. For example, in some instances, an instruction control unit 114 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 107, a compiled instruction; and providing, based on the compiled instruction, a plurality of control signals to one or more (e.g., a plurality of) functional units 102 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 114 can include hardware configured to receive an instruction comprising one or more timing parameters (e.g., delay amounts, etc.) or repetition parameters, and output control signal(s) to the functional unit(s) 102 to cause the functional units to perform operations according to the timing or repetition parameters (e.g., at a predetermined clock cycle defined by a compiler, etc.). In some instances, the instruction control unit 114 can control a timing or a number of repetitions of the functional unit(s) 102 by sending control signals comprising timing or repetition data, or by sending raw control signals at a specific time or plurality of times configured to cause the functional unit(s) 102 to perform operations according to one or more timing or repetition parameters.

In some instances, timing and synchronization units 105 can include various components configured to perform synchronization operations, such as operations to track or communicate time data (e.g., current clock cycle data, etc.) to one or more functional units 102 or other components of a processor device 101. In some instances, timing and synchronization units 105 can include one or more of: one or more hardware-aligned counters 115, one or more software-aligned counters 116, or other timing or synchronization component.

Hardware aligned counters 115 may be used to establish a time base for electronic circuitry in each system, such as a clock, for example. Additionally, each system may include software aligned counters 116. Software aligned counters 116 may be synchronized, for example, based on one or more computer-executable instructions (e.g., compiled instructions determined by a compiler, etc.). Hardware aligned counters 115 and software aligned counters 116 may be implemented as digital counter circuits, for example, on each integrated circuit (e.g., each processor device 101 or each die thereof, etc.). For instance, hardware aligned counters 115 may be free-running digital counters (e.g., 8-bit counters) on a processor device 101 that are synchronized periodically. Similarly, software aligned counters 116 may be digital counters (e.g., 8-bit counters) that are synchronized based on timing markers triggered by one or more compiled programs.

In some instances, timing and synchronization units 105 can include one or more components 105 for internal synchronization of a plurality of components (e.g., functional units 102, etc.) of a processor device 101; one or more components 105 for external synchronization between a first processor device 101 and one or more other devices (e.g., a plurality of second processor devices 101, etc.); or both.

In some instances, synchronizing a first device (e.g., first processor device 101 or another device) with a second device (e.g., second processor device 101 or another device, etc.) can include, for example, synchronizing one or more hardware aligned counters 115 of the first processor device 101 with one or more hardware aligned counters of the second device. Synchronizing the hardware aligned counters 115 may occur periodically during the operation of each system and may occur at a higher frequency than synchronizing software counters 116, for example. Synchronizing hardware counters may include the first device sending a timing reference (e.g., timing bits representing a time stamp) to the second device over a communication channel (e.g., via chip-to-chip communication units 112, etc.). In some instances, a first system may send an 8-bit time stamp, for example. In such a scenario, a hardware counter 115 and software counter 116 of the first device may be maintained in sync locally. However, as the hardware counter 115 on a first device is synchronized to the hardware counter 115 on a second device, the software counter 116 on the second device may drift.

In some instances, software aligned counters 116 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices'hardware aligned counters 115 are synchronized. In some instances, these timing markers may be used to synchronize software counters 116 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 116 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 115 of a pair of devices can include sending, by a first device at a first time t0, a timing reference; and receiving, at a second time t1 by a second device, the timing reference. In some instances, the latency of such a transmission may be characterized and designed to be a known time delay Δt=t₁-t₀. In such instances, synchronizing the pair of devices can include setting, by the second device, a hardware aligned counter 115 to a value of (t0+Δt) such that the hardware aligned counters 115 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 116 can be synchronized in a manner similar to synchronization of hardware aligned counters 115. For example, in some instances, a software aligned counter 116 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 101 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 2 is a block diagram of an example processor device 201 comprising a plurality of functional units 202 and a plurality of instruction control units 214. In some instances, processor device 201 can be configured to transmit (e.g., stream, propagate, etc.) operand data along a data flow axis 218 and transmit instruction data along an instruction flow axis 219. In some instances, the processor device 201 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 202 for executing the instruction at a predetermined time (e.g., clock cycle) selected by the compiler. In some instances, a processor device 201 can be configured to access one or more external memory modules 220 (e.g., near-compute external memory modules 220, etc.), such as one or more external dynamic random access memory (DRAM) modules 221.

In some instances, a processor device 201 can be, comprise, be comprised by, or otherwise share one or more properties with a processor device 101. For example, in some instances, a processor device 201 can have any property described herein with respect to a processor device 101, and vice versa.

In some instances, a functional unit 202 can be, comprise, be comprised by, or otherwise share one or more properties with a functional unit 102. For example, in some instances, a functional unit 202 can have any property described herein with respect to a functional unit 102, and vice versa.

In some instances, a data flow axis 218 can include a direction, axis, or path along which operand data can flow. For example, in some instances, one or more functional units 202 can be configured to receive one or more input operands along the data flow axis; process the input operands to generate one or more output values; and transmit the output values along the data flow axis 218 to another functional unit 202, which can use the output values as input operands, and so on. In some instances, functional units 202 configured to perform related operations (e.g., pairs of operations associated with some machine-learned inference pipelines, etc.) can be located close together along the data flow axis 218; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learned inference operations, etc.). For example, in some instances, a series of related operations for machine-learned inference can include one or more of: matrix multiplication (e.g., multiplying machine-learned model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 218 can include a physical axis or a logical axis, such as an operand flow path that may include or not include a straight-line operand flow path. In some instances, all or part of a data flow axis 218 can be orthogonal (e.g., logically orthogonal, physically orthogonal, etc.) to an instruction flow axis 219.

In some instances, an instruction flow axis 219 can include a direction, axis, or path along which instruction data can flow. For example, in some instances, an instruction control unit 214 can be configured to provide, to one or more first functional units 202, an instruction; and the first functional unit(s) 202 can be configured to execute the instruction and/or pass the instruction along to neighboring functional units 202 along the instruction flow axis 219. In some instances, a plurality of neighboring functional units along the instruction flow axis 219 can include a plurality of functional units 202 performing similar (e.g., same) functions, such as a plurality of memory functional units or the like. In some instances, a plurality of neighboring functional units along the instruction flow axis 219 can include a plurality of functional units 202 configured to execute the same instruction received from an instruction control unit 214 and propagated along the instruction flow axis. In some instances, an instruction flow axis 219 can include a physical axis or a logical axis, such as an operand flow path that may include or not include a straight-line operand flow path. In some instances, all or part of an instruction flow axis 219 can be orthogonal (e.g., logically orthogonal, physically orthogonal, etc.) to a data flow axis 218.

In some instances, a processor device 201 can include a deterministic processor device 201 comprising a plurality of deterministic functional units 202 configured to perform one or more operations at a predetermined time defined by a compiler at compile time. In some instances, a compiler can control a timing of one or more instruction and data flows to cause one or more instructions traversing the instruction flow axis 219 to intersect one or more operands traversing the data flow axis 218 at a functional unit 202 scheduled to execute the instruction(s) on the operand(s) at a predefined time instant selected by the compiler.

In some instances, a processor device 201 can include a plurality of functional units 202 (or “tiles”), which can include functional units 202 arranged in a tiled arrangement on a processor die. The functional units 202 can perform various functions such as vector-matrix multiplication, switching of data along different circuit pathways, and local data storage and retrieval. In some instances, functional units 202 can share a common system clock. In some instances, functional units 202 can include one or more sets of interconnected functional units 202 processing the same data, such as interconnected functional units 202 that are adjacent along a data flow axis 218; at a same location along an instruction flow axis 219; or the like. In some instances, a plurality of interconnected functional units 202 processing the same data can be referred to herein as a “lane” or “Superlane.” For example, in some instances, each functional unit 202 in a Superlane can be subdivided into 16 sub-units, and a set of subunits processing the same data can be referred to herein as ‘lanes’. A set of data that is processed by one Superlane is referred to herein as a ‘stream’. In some instances, each lane in a unit of a Superlane can be configured to process one byte (e.g., one byte per clock cycle, one byte at a time, etc.).

In some instances, an instruction control unit 214 can be, comprise, be comprised by, or otherwise share one or more properties with an instruction control unit 114. For example, in some instances, an instruction control unit 214 can have any property described herein with respect to an instruction control unit 114, and vice versa.

In some instances, data between two adjacent functional units 202 can flow bidirectionally, or can primarily (e.g., most or all of the time) move in one direction along a lane or Superlane. In some instances, a first Superlane can have a direction of flow along the data flow axis 218 that is the same as or different from a direction of flow of a second Superlane. In some instances, operand data can be transferred along the data flow axis 219 at every clock cycle of a processor device 201. In some instances, when processing of operand data is complete in one Superlane, the data can be either returned to a host computer comprising the processor device 201 or transferred (e.g., by permute/routing functional units 111, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 201 contains N (e.g., 20, etc.) adjacent Superlanes, then an instruction can be passed to N adjacent functional units 202 (e.g., over the course of N clock cycles, etc.), and each instruction can execute on all 16*N (e.g., 320) lanes across the N Superlanes. In some instances, a processor device 201 architecture can include an architecture that lacks register files, and a compiler can schedule the streaming data to be available to the functional unit 202 at a predetermined designated time to execute a designated instruction.

An external memory module 220 can include, for example, a memory device that is external to the processor device 201, such as a memory device on a separate die from the processor device 201 or the like. In some instances, an external memory module 220 can have one or more properties that are the same as or different from one or more properties of a memory functional unit 107. For example, in some instances, an external memory module 220 can include any memory type or device type described herein with respect to a memory functional unit 107. As another example, in some instances, an external memory module 220 can use a first type of memory that is different from a second type of memory used in an on-chip memory functional unit 107. For example, in some instances, a memory functional unit 107 can include a low-latency memory type such as SRAM, and an external memory module 220 can use one or more lower-cost or higher-storage-capacity memory types, such as dynamic random access memory (DRAM). Other memory types are possible without deviating from the scope of the present disclosure (e.g., SRAM or other non-volatile memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory module can have any property described herein with respect to an external dynamic random access memory (DRAM) module 221, and vice versa.

In some instances, an external dynamic random access memory (DRAM) module 221 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory module 220, 221 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory module 220, 221 can include a plurality of memory banks, wherein each bank has a plurality of rows for storing data. Each memory bank can be addressable by a processor device 201 for writing data to selected rows in selected banks and for reading data from selected rows in selected banks, wherein data can be read a predetermined time-period before the data is required to arrive at one or more compute element(s) of the processor 201 and data can be written to a memory at a first pre-determined time-period that does not coincide with a memory refresh scheduled to occur at a second predetermined time.

In some instances, an external memory module 220, 221 can include various features to enable high-bandwidth memory access, high levels of memory concurrency, or the like. For example, in some instances, an external memory module 220, 221 can provide deterministic memory access functions (e.g., deterministic-latency operations, etc.) to enable a compiler to control a timing of a plurality of data read, write, or refresh operations; control a level of memory concurrency for accessing a plurality of operands or other data from an external memory module 220, 221; or other memory control functions. As another example, in some instances, an external memory module 220, 221 can include a plurality of concurrently accessible memory banks (e.g., memory banks configured to be active simultaneously, etc.), thereby increasing a memory bandwidth of the external memory module 220, 221. In some instances, an external memory module 220, 221 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory module 220, 221 operations.

In some instances, an external memory module 220, 221 can include a deterministic memory module having low-random-transaction-rate (low-RTR) memory (e.g., DRAM banks, etc.), and a processor device 201 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory module 220, 221 can have one or more features to reduce a power consumption of the external memory module 220, 221 compared to some alternative implementations. For example, in some instances, an external memory module 220, 221 can be placed in close proximity to a processor device 201 to reduce (e.g., minimize or nearly minimize) an amount of power consumed in reading or writing data to the memory module 220, 221 (e.g., due to lower capacitive loading of short signal traces, etc.). In some instances, placing an external memory module 220, 221 in close proximity to a processor device 201 can include connecting the module 220, 221 to the processor device 201 in various manners, such as by face-to-face coupling (e.g., using wafer stacking technology, etc.) or another connection technique (e.g., passive interposer, active interposer, etc.). In some instances, a low-power external memory module 220, 221 can include a memory component (e.g., DRAM component) having sense amps attached directly to row input/output (e.g., without a logic layer or without data buffer(s), etc.).

In some instances, an external memory module 220, 221 can include one or more logic dies and a plurality of memory banks, such as a logic die coupled to a plurality of DRAM banks by through-silicon via and to a processor device 201 in a face to face configuration, etc. In some instances, a logic die can include row buffers for interfacing the processor device 201 to one or more memory components. The memory component(s) can also have an array core and a row decoder. During a read operation, the row decoder can select a row of array core and the entire row from the selected row can be transferred from the memory component to row buffers on the logic die. In some instances, a memory component or an external memory module 220, 221 can lack column decoders and can read or write an entire row during each R/W cycle. In some instances, a memory plane can include 3D NOR memory.

In some instances, an external memory module 220, 221 can provide a global address space available to a plurality of functional units 202. For example, in some instances, global memory access can be facilitated by one or more permute/routing functional unit(s) 111 of a processor device 201 to allow any processor 201 component at any location on a die to access data residing in any memory bank element of an external memory module 220, 221 or memory functional unit 107.

For example, in some instances, a streaming processor device 201 can provide operand data movement along a data flow axis 218 automatically (e.g., at every clock cycle, etc.), while one or more permute/routing functional unit(s) 111 can provide (e.g., responsive to one or more compiled instructions, etc.) operand data movement along an instruction flow axis 219.

In some instances, a processor device 201 can have sufficient permute/routing functional unit(s) 111 or data flow operations (e.g., routed data flow, automatic or unrouted data flow, etc.) to enable any retrieved data to be mapped to any functional unit 102 or port thereof. In some instances, permute/routing functional unit(s) 111 can provide additional operations in association with memory retrieval, such as data reshaping, padding (e.g., padding a size of a tensor by adding a plurality of zeros, etc.), duplication, or other data routing operations.

In some instances, a processor device 201 and external memory module 220, 221 can operate deterministically (e.g., with deterministic timing, order of operations, etc.), and can have various features to take advantage of such determinism. For example, in some instances, a deterministic processor device 201 can initiate one or more data retrieval operations a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to enable lower-RTR memory device(s) to perform similarly to a high-RTR memory of some alternative implementations. As another example, in some instances, given a processor device 201 that is deterministic, an external memory module 220 can perform non-destructive row reads, as each row can write new data if aligned with a closing row. This can provide for, for example, improved performance, reduced power usage, or both. In some instances, a deterministic processor device 201 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 201 can also treat the external memory module(s) 220, 221 as a circular read/write access medium having an opportunity to read and write every row location. For example, a row address line of an off-chip deterministic near-compute memory unit 220, 221 can be coupled to a clock. The row address line can be configured to receive a row address from the processor device 201 and increment every clock cycle in accordance with the circular medium access until the row address loops back without explicit addressing. This pattern can provide for even further power reduction and performance improvement while implicitly incorporating refresh support.

In some instances, a processor device 201 can use one or more memory functional unit(s) 107 (e.g., SRAM units, etc.) or another buffer device (e.g., external SRAM units interposed between a processor device 201 and external DRAM module 221, etc.) as a buffer to temporarily store data retrieved from the external memory module(s) 220, 221, or the processor device 201 can be configured to provide retrieved data directly to one or more functional unit(s) 202 for processing or routing (e.g., traversal of a data flow axis 218, etc.).

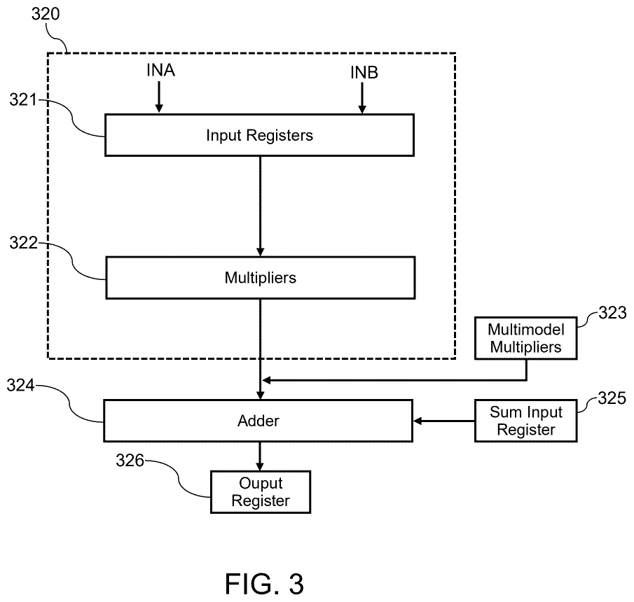

FIG. 3 is a block diagram of an example multimodal multiplier circuit 320 according to one implementation. The multimodal multiplier circuit of FIG. 3 may be a building block of the functional unit(s) 102 of FIG. 1. Features and advantages of the present disclosure include multimodal multiplier circuits that may receive and process different data types with different numbers of bits in different modes and share circuitry, which may advantageously reduce circuit area and may improve the speed and efficiency of processing data, for example.

For instance, a multimodal multiplier circuit 320 may include one or more input storage register circuits 321 for storing digital bits representing input operands to be multiplied. The storage register circuits 321 may store different numbers of operands to be multiplied together in different modes, and the operands may have different data types and different numbers of bits. Storage register circuits are circuits that store digital bits, such as a plurality of flip flops or other digital storage circuits known to those skilled in the art. A single storage register circuit may be partitioned into multiple storage register circuits, for example, to store different digital values (e.g., operands).

In one implementation, in a first mode, the one or more storage register circuits 321 store one first operand and one second operand having a first data type, and in a second mode the one or more storage register circuits store a first plurality of operands and a second plurality of operands having a second data type. A plurality of multiplier circuits 322 may be configured to receive the one or more first operands and the one or more second operands, for example. As illustrated in various implementations disclosed herein, multipliers may be shared across modes. For example, in a first mode, two operands having the first data type are multiplied in one or more of the plurality of multiplier circuits 322. In a second mode, a first plurality of operands and a second plurality of operands are multiplied in the plurality of multiplier circuits 322. The first and second plurality of operands multiplied in the second mode may have fewer bits than the first and second operands multiplied in the first mode, for example. However, one or more of the multiplier circuits may be used for both modes. For example, in one implementation, at least one of the plurality of multiplier circuits is used to multiply operands in both the first mode and the second mode. In another implementation, a number of multiplier circuits used to multiply operands in the first mode is the same as the number of multiplier circuits used to multiply operands in the second mode.

As further illustrated in FIG. 3, in some implementations, multimodal multiplier circuits 320 may be combined to form multimodal multiply-accumulator circuits. For example, an output of multimodal circuit 320 may comprise output product values having different data types or even different numbers of output products in different modes, for example. Output products of a plurality of other multimodal multipliers 323 may be summed with output products of multimodal multiplier 320 in adder 324 to produce a multimodal multiply-accumulator. Additionally, in other implementations disclosed herein, an input register 325 may receive an input value (e.g., an output of another multiply-accumulator) and adder 324 may sum locally generated products with sums generated by other multimodal multiply accumulators, for example. An output register 326 may store a summed result and may couple the result to additional multiply-accumulator circuits, for example. Arrays of such multimodal multiply-accumulate circuits may be configured to process large volumes of operands having different data types, for example. Implementations of the disclosure may be particularly advantageous in machine learning (aka artificial intelligence) digital processing circuit applications, where the one or more first operands are weights and the one or more second operands are activation values, for example.

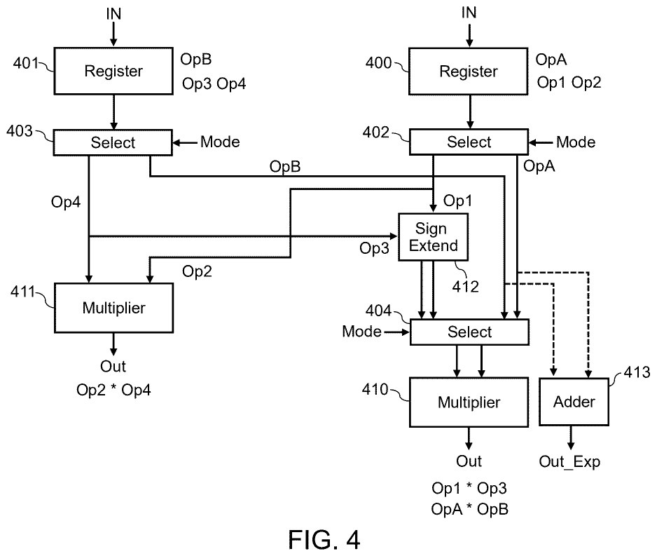

FIG. 4 is a block diagram of an example multimodal multiplier circuit according to another implementation. The multimodal multiplier circuit of FIG. 4 may be a building block of the functional unit(s) 102 of FIG. 1. In this example, storage register circuit 400 may store digital bits corresponding to one or more first operands. Similarly, a second storage register circuit 401 may store digital bits corresponding to one or more second operands. As mentioned above, registers 400 and 401 may be one partitioned register or multiple distinct registers, for example. In a first mode, the first and second storage register circuits 400 and 401 each may store one first operand and one second operand having a first data type (e.g., OpA and OpB, respectively), and in a second mode the first storage register circuit 400 stores a first plurality of operands (e.g., Op1 and Op2) and the second storage register circuit 401 stores a second plurality of operands (e.g., Op3 and Op4) having a second data type. In one implementation, operands having the first data type may comprise a greater number of bits than operands having the second data type, for example. In one implementation, operands having the first data type comprise floating point values, for example, and operands having the second data type comprise integer values, for example.

Referring again to FIG. 4, first and second multiplier circuits 410 and 411 are coupled to the first and second storage register circuits 400 and 401. In a first mode, one first operand (e.g., OpA) in the first storage register circuit 400 and one second operand (e.g., OpB) in the second storage register circuit 401 are coupled to the first multiplier circuit 410. In a second mode, a first operand of the first plurality of operands (e.g., Op1 of Op1 and Op2) in the first storage register circuit 400 and a first operand of the second plurality of operands (e.g., Op3 of Op3 and Op4) in the second storage register circuit 401 are coupled to the first multiplier circuit 410 and a second operand of the first plurality of operands (e.g., Op2 of Op1 and Op2) in the first storage register circuit 400 and a second operand of the second plurality of operands (e.g., Op4 of Op3 and Op4) in the second storage register circuit 401 are coupled to the second multiplier circuit 411. In this example, select circuits (e.g., multiplexers) 402 and 403 may be used to selectively couple operands from input storage registers to particular multipliers based on a mode control signal. For example, in a first mode, select circuit 402 may couple OpA from register 400 to one input of multiplier 410, and select circuit 403 may couple OpB from register 401 to another input of multiplier 410. In a second mode, registers 400 and 401 may each receive and store two operands on each multiplication processing cycle. Accordingly, in the second mode, select circuit 402 couples Op1 to one input of multiplier 410 and couples Op2 to one input of multiplier 411. Similarly, in the second mode, select circuit 403 couples Op3 to another input of multiplier 410 and couples Op4 to another input of multiplier 411. Accordingly, in some modes, data may be multiplied in parallel and multipliers may be shared across multiple modes, for example.

As mentioned above, operands having the first data type (e.g., floating point values) may have a greater number of bits than operands having the second data type (e.g., integers). Accordingly, multiplier circuit 410 may be configured to multiply inputs having a greater number of bits than multiplier circuit 411, for example. In this example, operands having the second data type entering multiplier 410 may be sign extended to match the extended bit capabilities of multiplier circuit 410. For instance, the multimodal multiplier circuits may further comprise a sign extension circuit 412 coupled to outputs of the first and second storage register circuits 400 and 401 to receive, in the second mode, one of the first plurality of operands (e.g., Op1) from the first storage register circuit 400 and one of the second plurality of operands (e.g., Op3) from the second storage register circuit 401, for example. Sign extension circuit 412 may increase the number of bits of each binary number (e.g., Op1 and Op3) while preserving the number's sign (positive/negative) and value, for example. Another select circuit 404 receives the mode control signal to couple inputs of multiplier 410 to either outputs of the sign extension circuit 412 to receive operands of the second data type, or alternatively, to outputs of select circuits 402 and 403 to receive operands of the first data type.

As mentioned above, in some applications operands coupled to input registers 400 and 401 may be floating point numbers. Accordingly, a multimodal multiplier circuit may further comprise an adder circuit 413. In one mode, exponent bits of one operand (e.g., a floating point operand) in storage register circuit 400 and exponent bits in a second operand (e.g., another floating point operand) in storage register circuit 401 are coupled to adder circuit 413 (designated as dashed lines for when floating point is used). Floating point values may have the form “significand×base\hat{ }exponent” where the exponent of two FP operands may be added in adder 413 and significands (aka the mantissa) of the FP operands are multiplied in multiplier 410, for example. Floating point numbers may be represented in the system using more bits than integers, for example, and thus multiplier 410 may have more bits than multiplier 411, which may only multiply operands having the second data type, for example. As described in more detail below, outputs of multipliers 410 and 411 and adder 413 may be further processed and added to other multiplier outputs.

One example application of the techniques described herein is in machine learning processors (aka artificial intelligence processors, e.g., neural networks). Such processors may require volumes of multiply-accumulate functions, and it may be desirable in many applications to flexibly process input data represented in a variety of different data types, such as signed integer, unsigned integer, or floating point (e.g., FP16 IEEE 754). Accordingly, in one implementation, the first operands are weights and the second operands are activation values and the circuits and methods described herein are implemented in a machine learning processor. For example, one mode may configure a machine learning processor to multiply floating point (FP) numbers. Accordingly, a first FP operand corresponding to a weight may be stored in register 400 and a second FP operand corresponding to an activation (e.g., a pixel value of an input image) may be stored in register 401. In the example shown in FIG. 4, the significand of the first and second FP operands are coupled to a wide bit format multiplier 410, for example, and the exponent bits of the FP operands are coupled to adder 413 to produce an output product (e.g., OpAOpB×exp\hat{ }(out_exp)). In a second mode, the machine learning processor may multiply integer numbers. In the second mode, two 8-bit integers, for example, may be stored in each of registers 400 and 401. More specifically, two integer weights may be stored in register 400 and two integer activations may be stored in register 401. One activation and one weight may be coupled to a sign extend circuit so the integers match the wider format of multiplier 410, for example, and another activation and weight are coupled to multiplier 411 to be advantageously multiplied in parallel. Outputs of multipliers 410 and 411 (e.g., Op1Op3 and Op2*Op4) may be further combined together, for example. and with other multiplier outputs as described in more detail below. Activations and weights may alternatively be multiplied together using the techniques illustrated in FIG. 4, for example.

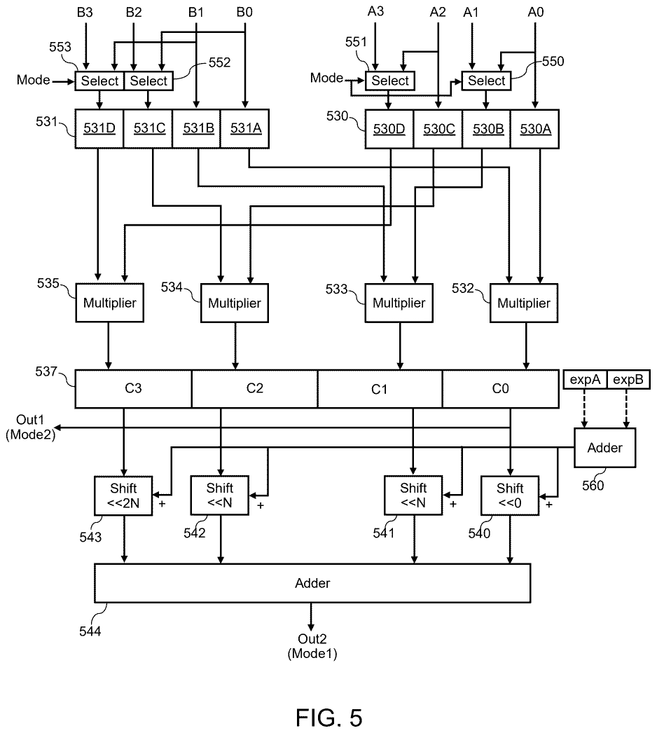

FIG. 5 is a block diagram of an example multimodal multiplier circuit according to yet another implementation. The multimodal multiplier circuit of FIG. 5 may be a building block of the functional unit(s) 102 of FIG. 1. In this example, one or more operands, A, may be received in a first storage register circuit 530 and one or more second operands, B, may be received in a second storage register circuit 531. A plurality of multipliers 532-535 are coupled to particular segments of registers 530 and 531 to receive the one or more operands. In this example, different operands, or components of each operand, may be positioned in different locations in registers 530 and 531 based on the mode so that multipliers 532-535 may be efficiently shared.

For example, in one mode A and B both correspond to four (4) operands A0-A3 and B0-B3 (e.g., a total of eight 8-bit integers). Accordingly, operands A0-A3 are stored in register segments 530A-D, respectively, and operands B0-B3 are stored in register segments 531A-D, respectively. Multiplier 532 has one input coupled to segment 530A of register 530 and a second input coupled to segment 531A of register 531 to receive operands A0 and B0. Similarly, multiplier 533 has one input coupled to segment 530B and a second input coupled to segment 531B to receive operands A1 and B1, multiplier 534 has one input coupled to segment 530C and a second input coupled to segment 531C to receive operands A2 and B2, and multiplier 535 has one input coupled to segment 530D and a second input coupled to segment 531D to receive operands A3 and B3. Accordingly, in one mode, multipliers 532-535 may multiply two sets of four 8-bit integer operands. The output product values of multipliers 532-535, C0=A0B0, C1=A1B1, C2=A2B2, and C3=A3B3, may be stored in register 537, which may provide a first output (Out1) in one of the modes, for example. C0-C3 may be concatenated and added to output products of other multimodal multiplier circuits as described below.

In another mode, the circuit may receive operands A and B having a different data type with a greater number of bits. For example, operands A and B may be a 16-bit floating point numbers. Accordingly, these operands may be stored as components in different register segments of registers 530-531. For example, one operand A may be stored as two components in two register segments in register 530, and another operand B may be stored as two components in two register segments in register 531. In one implementation, operand A comprises a first component (e.g., lower order bits) received on A0 and stored in register segment 530A and a second component (e.g., higher order bits) received on A2 and stored in register segment 530C. Operand B comprises a first component (e.g., lower order bits) received on B0 and stored in register segment 531A and a second component (e.g., higher order bits) received on B1 and stored in register segment 531B, for example.

Aspects of the present disclosure may provide for selectively coupling different input bits into different register segments in different modes. For example, in this mode, the first component of A on input A0 may be coupled to and stored in register segment 530B, and the second component of A on input A2 may be coupled to and stored in register segment 530D. Similarly, the first component of B on input B0 may be coupled to and stored in register segment 530C, and the second component of B on input B1 may be coupled to and stored in register segment 531D. The selective arrangement of inputs in different register segments for different modes is illustrated in FIG. 5 using select circuits (e.g., multiplexers) 550-553. Accordingly, in this mode, multiplier 532 receives the first component (on A0) of operand A and the first component (on B0) of operand B, multiplier 533 receives the first component (on A0) of operand A and the second component (on B1) of operand B, multiplier 534 receives the second component (on A2) of operand A and the first component (on B0) of operand B, multiplier 535 receives the second component (on A2) of operand A and the second component (on B1) of operand B. In other words multipliers 532-535 perform the following multiplications A0B0, A0B1, A2B0, and A2B1, where A0 are the lower order (less significant) bits of A, A2 are the higher order (more significant) bits of A, B0 are the lower order (less significant) bits of B, and B1 are the higher order (more significant) bits of B.

Output product values C0-C3 of components of the inputs may be stored in register 537, for example. In this mode, outputs of multipliers 532-535 may be coupled to shift circuits 540-543. Outputs of shift circuits 540-543 are coupled to an adder circuit to produce an output product of the inputs A*B. For example, C0 may be coupled to shift circuit 540, which may have a nominal shift value of 0, C1 may be coupled to shift circuit 541, which may have a nominal shift value of N (where N is the number of bits of the input component e.g., N=8 for an 8 bit component into each multiplier), C2 may be coupled to shift circuit 542, which may have a nominal shift value of N, and C3 may be coupled to shift circuit 543, which may have a nominal shift value of 2N. Each shift circuit may perform a left shift, for example. Accordingly, in this example, products of lower order bits A0B0 are not shifted, products of higher and lower order bits A2B0 and B1A0 are shifted by N, and products of higher order bits A2B1 are shifted by 2N. From the above it can be seen that in some implementations no shifter 540 may be included since C0 may not be shifted. However, in one implementation, exponent bits of floating point operands, expA and expB, may be input to adder circuit 560 and added together and the result used to increase the shift performed by each shift circuit. For example, an output of adder circuit 560 is coupled to a control input of each shift circuit 540-543 so that the sum of exponent bits expA and expB may increase the shift of each shift circuit (e.g., expA1; expB2; increase each shift by 3). The outputs of the shift circuits are summed in an adder circuit 544, which may comprise a plurality of N-bit adders, for example. The shifted and added output product values may provide a second output (Out2) in one of the modes, which may be a fixed-point representation, for example. Accordingly, in some implementations, multiplication of the inputs may result in output products being converted to a third data type, which may be added to output products of other multimodal multiplier circuits as described below.

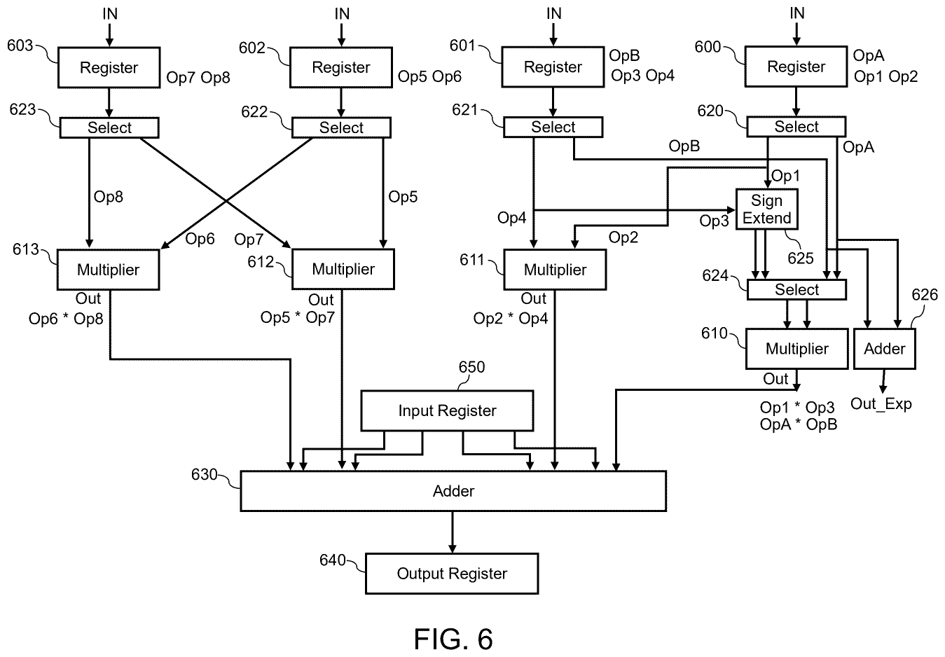

FIG. 6 is a block diagram of an example multimodal multiplier circuit according to another implementation. The multimodal multiplier circuit of FIG. 6 may be a building block of the functional unit(s) 102 of FIG. 1. Some implementations of the present disclosure may receive and process operands in one mode with high precision, including bit lengths long enough such that, when in another mode, multiple lower bit length operands may be processed in a plurality of parallel multipliers. In this example, registers 600-601 and multiplier 610 may process operands in a first data type (e.g., a float) in one mode, and a difference in bit representations in the system may allow processing of N (where N is an integer, e.g., N=4) operands having a second data type (e.g., integer) in another mode. Multiplier 610 may process one operand from each register 600-601 in a first mode, and multipliers 610 and 611 may combine two operands from each register 600-601 in a second mode. Additionally, the multimodal multiplier circuit shown in FIG. 6 may further comprise a third storage register circuit 602 for storing digital bits corresponding to two additional operands (Op5, Op6) and a fourth storage register circuit 603 for storing digital bits corresponding to two more operands (Op7, Op8), where Op5-Op8 have the second data type with fewer bits than the first data type (e.g., INT8 v. FP16). In one implementation, register 602 stores weight values and register 603 stores activation values.

The circuit in FIG. 6 may further include multipliers 610, 611, 612 and 613. Select circuits 620, 621, 622 and 623 couple operands in registers 600, 601, 602 and 603 to multiplier circuits 610, 611 612 and 613. For example, multiplier circuit 612 may be coupled to storage register circuits 602 and 603 to receive an operand (e.g., Op5) from storage register circuit 602 and another operand (e.g., Op7) from storage register circuit 603. Similarly, multiplier circuit 613 may be coupled to storage register circuits 602 and 603 to receive an operand (e.g., Op6) from storage register circuit 602 and another operand (e.g., Op8) from storage register circuit 603. In a machine learning application, Ops 5-6 may be weights and Ops 7-8 may be activation values. Accordingly, the output of each multiplier is an activation multiplied by a weight. For example, multiplier 612 can be configured to multiply the weight of Op5 by the activation of Op7, and/or the multiplier 613 can be configured to multiply he weight of Op6 by the activation of Op8. Advantageously, in the second mode, four multiplications may be performed in parallel.

In the second mode, the outputs of each multiplier 610-613 may be coupled to an adder 630, which may sum (or accumulate) products, for example. The final output may be stored in an output register 640. Additionally, a sign extend circuit 625, a select circuit 624, and adder 626 can provide for generating an output exponent to be provided in chaining multiple multimodal multipliers together. In one implementation, the output products from multipliers 610-613 are added to corresponding values in an input register 650, for example. As described further below, some implementations may accumulate products of activations and weights (x*wt) along a column of multipliers (not shown), for example. Accordingly, in this example, input register 650 may store four (4) values of the integers (A1, A2, A3, A4), which are added to the four corresponding output products from multipliers 610-613 (R1, R2, R3, R4). The result is four (4) corresponding output values in output register 640 (A1+R1, A2+R2, A3+R3, A4+R4), which may be coupled to an input register of another group of multipliers, for example.

As described in more detail below, some implementations of multiplier 610 may, in the first mode, produce floating point values, which are then converted to a third data type, such as fixed-point, having an extended bit length, to achieve wide dynamic range and accuracy. In one implementation, a fixed-point value may comprise a number of bits equal to at least N (e.g., N=4) times the number of bits produced by products of operands (e.g., Op4Op2, Op5Op7, Op6*Op8) having the second data type (e.g., 8-bit integer). Accordingly, the same adder 630 and output register 640 may be used to store one extended length data type or multiple integer data types, for example, which may have advantages including reduced circuit area, for example.

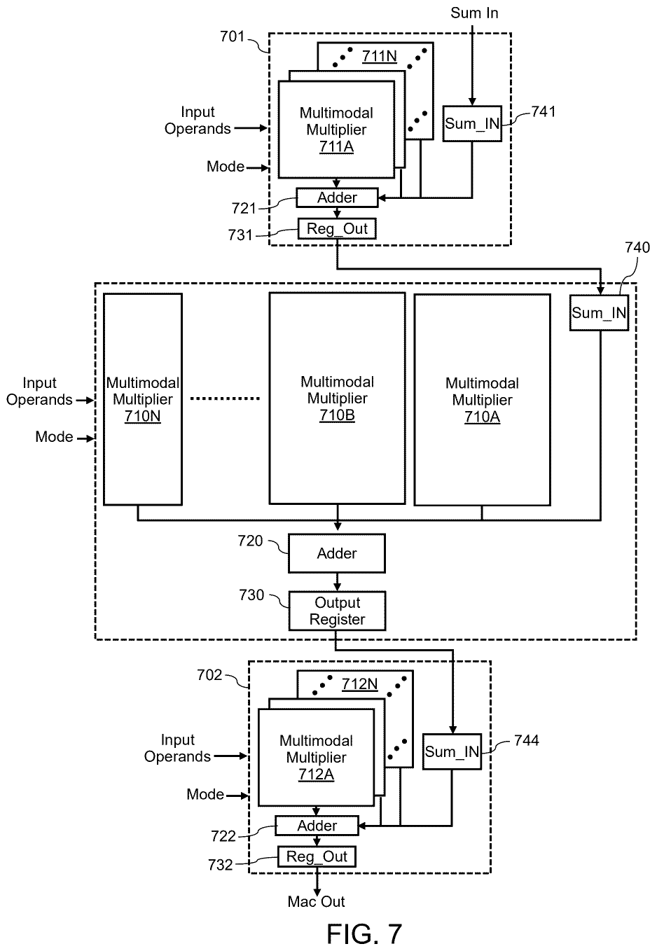

FIG. 7 illustrates a multimodal multiply-accumulator circuit according to another embodiment. The multimodal multiply-accumulator circuit of FIG. 7 may be a building block of the functional units 102 of FIG. 1. In this example, a plurality of multimodal multipliers are configured in parallel, and outputs of the multipliers are coupled to inputs of an adder circuit to form a multiply-accumulator. Additionally, groups of multiply-accumulator circuits may be configured in series. For instance, multimodal multiplier circuits 710A-N may receive input operands in a first or second data type and a mode control signal (“mode”) to configure the multiplier circuits to process different types of inputs. Each multimodal multiplier 710A-N may receive a pair of operands having the first data type (e.g., FP16) in a first mode. Alternatively, each multimodal multiplier 710A-N may receive a plurality of pairs of operands having the second data type (e.g., INT8) in a second mode. The pairs of operands may be activation values and weights of a neural network, for example, where the circuit in FIG. 7 may be included in a machine learning digital data processing circuit.

The outputs of each multimodal multiplier 710A-N may be coupled to adder 720. In the first mode, adder 720 sums values having a third data type (e.g., fixed-point), where each multimodal multiplier 710A-N converts a product of the input operands from the first data type (e.g., float) to the third data type (e.g., extended length fixed-point) as mentioned above. In a second mode, adder 720 sums values having the second data type (e.g., integer). In one embodiment, product values from a particular multiplier in each multimodal multiplier 710A-N are added to product values from corresponding multipliers. For example, referring to the product from a multiplier in one multimodal multiplier 710A can be added to the products from a multiplier in the other multimodal multipliers 710B-N, and the product from a second multiplier in one multimodal multiplier 710A is added to the products from a second multiplier in the other multimodal multipliers 710B-N, and so on. Accordingly, results from columns of multipliers in an array of multiplier circuits may be combined independently (e.g., as arrays of values). Outputs of adder 720 are stored in output register circuit 730, which stores a single output value in the third data type, for example, in the first mode and multiple output values having the second data type in the second mode, for example.

In some embodiments, each multiply-accumulator circuit 700 and 702 may comprise an input register circuit having an input coupled to an output register circuit of another multimodal multiply-accumulator circuit. For example, multiply accumulator circuit 700 includes an input register 740, which may be configured to receive one or more sums from multiply-accumulator 701 (including a respective plurality of multimodal multipliers 711A-711N, an adder 721, an output register 731, and/or an input register 741) based on the mode the system is operating in, for example. Accordingly, when multiply-accumulator circuits 700 and 701 are in a first mode, input register 740 receives and stores a single input value, which may have the third data type (e.g., an extended fixed-point value), and when multiply-accumulator circuits 700 and 701 are in a second mode, input register 740 receives and stores a plurality of input values having the second data type (e.g., four (4) integer values).

An output of register 740 is coupled to the adder circuit 720. Accordingly, in the first mode, a plurality of values, one from each multimodal multiplier 710A-N, may be added together and further added to the single input value in register 740. Alternatively, in the second mode, multiple values from each multimodal multiplier 710A-N and the multiple values from input register 740 are added, where values corresponding to particular columns are added to other values corresponding to particular columns. For example, if there are four values in input register 740 and four multipliers used in each multimodal multiplier 710A-N in the second mode, then a first of the four values from register 740 may be added with values from N multipliers in each of 710A-N, a second of the four values from register 740 may be added with values from multipliers in each of 710A-N, and so on, which may result in four summed output values in output register 730. An output of the output register circuit 730 is coupled to multimodal multiply-accumulator circuit 702 (including, a respective plurality of multimodal multipliers 712A-712N, an adder 722, an output register 732, and/or an input register 742) and a similar process may be repeated, for example.

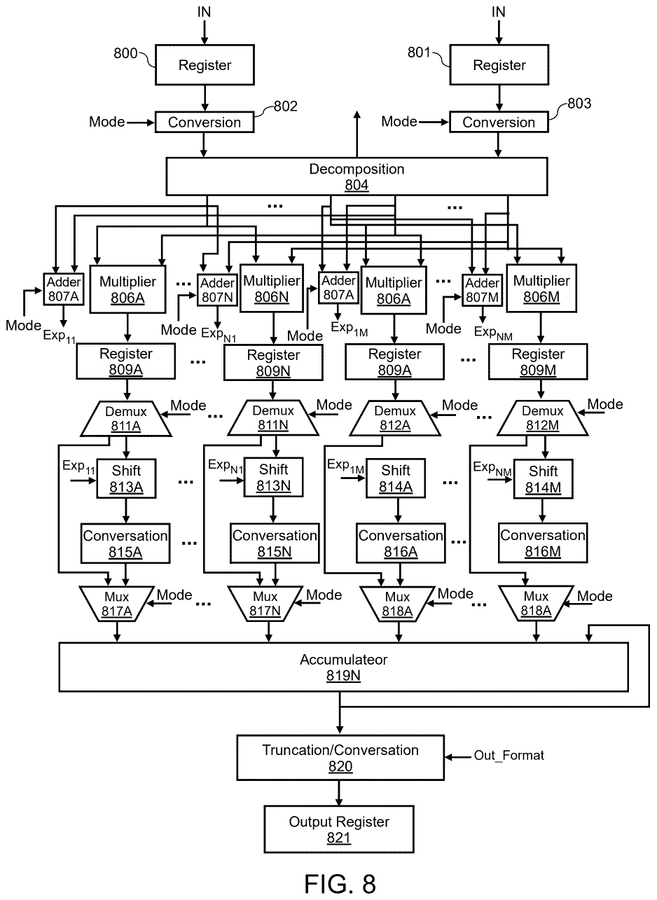

FIG. 8 illustrates multiplier circuitry utilizing a lossless format for accumulation of partial multiplication results according to an embodiment. The multiplier circuitry of FIG. 8 can be a building block of the functional units 102. In some embodiments, the multiplier circuitry of FIG. 8 is a component of an array of multipliers within, e.g., a matrix execution module (M×M). One or more storage register circuits 800, 801 store digital bits corresponding to an operand of a first format and another operand of the first format. The first format may be an INT4 format, an INT8 format, an INT16 format, a FP16 format (e.g., in accordance with the IEEE 754 standard) and a FP32 format (e.g., in accordance with the IEEE 754 standard), or some other numerical representation format. Conversion circuits 802, 803 may convert the operand and the other operand from a floating point format into an integer format prior to decomposition of the operand and the other operand. The conversion circuits 802, 803 may be bypassed, e.g., based on a Mode signal, when the first format of the operand and the other operand is an integer format. The Mode signal is a bit signal having a first value (e.g., “0”) when the first format is an integer format (e.g., INT4, INT8, INT16) and having a second value (e.g., “1”) when the first format is a floating point format (e.g., FP16, FP32). A decomposition circuit 804 decomposes the operand into a first plurality of operands (e.g., smaller integer numbers). The decomposition circuit 804 further decomposes the other operand into a second plurality of operands (e.g., smaller integer numbers). The decomposition circuit 804 may decompose the operand and the other operand by applying, e.g., a Toom-Cook decomposition algorithm. The first plurality of multipliers 806A, . . . , 806N and the second plurality of multipliers 808A, . . . , 808M are integer multipliers. When the first format is an integer format, each operand of the first plurality of operands is routed from the decomposition circuit 804 to each multiplier of a first plurality of multipliers 806A, . . . , 806N as well as to each multiplier of a second plurality of multipliers 808A, . . . , 808M. Similarly, each operand of the second plurality of operands is routed from the decomposition circuit 804 to each multiplier of the first plurality of multipliers 806A, . . . , 806N as well as to each multiplier of the second plurality of multipliers 808A, . . . , 808M. Each pair of operands from the first and second pluralities of operands are mutually multiplied in a corresponding multiplier of the first and second pluralities of multipliers 806A, . . . , 806N, 808A, . . . , 808M to generate a corresponding partial result of a plurality of partial results. The partial results generated by the multipliers 806A, . . . , 806N, 808A, . . . , 808M are stored in corresponding registers 809A, . . . , 809N, 810A, . . . , 810M. When the first format is a floating point format, a significand portion from each operand of the first plurality of operands is routed from the decomposition circuit 804 to each multiplier of the first plurality of multipliers 806A, . . . , 806N as well as to each multiplier of the second plurality of multipliers 808A, . . . , 808M. Similarly, a significand portion from each operand of the second plurality of operands is routed from the decomposition circuit 804 to each multiplier of the first plurality of multipliers 806A, . . . , 806N as well as to each multiplier of the second plurality of multipliers 808A, . . . , 808M. Each pair of significand portions from the first and second pluralities of operands are mutually multiplied in a corresponding multiplier of the first and second pluralities of multipliers 806A, . . . , 806N, 808A, . . . , 808M to generate a corresponding partial result stored in a corresponding register 809A, . . . , 809N, 810A, . . . , 810M. Additionally, an exponent portion from each operand of the first plurality of operands is routed from the decomposition circuit 804 to each adder of a first plurality of adders 805A, . . . , 805N as well as to each adder of a second plurality of adders 807A, . . . , 807M. Similarly, an exponent portion from each operand of the second plurality of operands are routed from the decomposition circuit 804 to each adder of the first plurality of adders 805A, . . . , 805N as well as to each adder of the second plurality of adders 807A, . . . , 807M. Each pair of exponent portions from the first and second pluralities of operands are mutually summed in a corresponding adder of the first and second pluralities of adders 805A, . . . , 805N, 807A, . . . , 807M to generate a corresponding exponent Exp11, . . . , Exp1N, Exp_1M, . . . , Exp_NM. When the first format is a floating point format, the first and second pluralities of adders 805A, . . . , 805N, 807A, . . . , 807M are not utilized. In such case, the adders 805A, . . . , 805N, 807A, . . . , 807M can be turned off based on the Mode signal, all zero bits are routed to the inputs of the adders 805A, . . . , 805N, 807A, . . . , 807M, or the adders 805A, . . . , 805N, 807A, . . . , 807M are bypassed in some other manner and their outputs are not utilized. When the first format is a floating point format, each partial result stored in the corresponding register 809A, . . . , 809N, 810A, . . . , 810M is shifted at a corresponding shift circuit 813A, . . . , 813N, 814A, . . . , 814M by a number of bits equal to a value of a respective exponent output from a corresponding adder 805A, . . . , 805N, 807A, . . . , 807M. Each shifted partial result is passed onto a corresponding conversion circuit 815A, . . . , 815N, 816A, . . . , 816M. Conversion circuits 815A, . . . , 815N, 816A, . . . , 816M convert the plurality of partial results to the TP format, i.e., to the fixed-point numerical representation. A position of a decimal point in the TP numerical representation of each shifted partial result is based on a value of the respective exponent. When the first format is an integer format, shifting and conversion are not required, i.e., the shift circuits 813A, . . . , 813N, 814A, . . . , 814M and the conversion circuits 815A, . . . , 815N, 816A, . . . , 816M are bypassed using, e.g., corresponding demultiplexers 811A, . . . , 811N, 812A, . . . , 812M controlled by an appropriate value of the Mode signal. In such case, the partial results stored in the registers 809A, . . . , 809N, 810A, . . . , 810M are directly provided to an accumulator circuit 819, e.g., via corresponding multiplexers 817A, . . . , 817N, 818A, . . . , 818M controlled by an appropriate value of the Mode signal. When the first format is a floating point format, the shifted partial results at the outputs of the conversion circuits 815A, . . . , 815N, 816A, . . . , 816M are provided to the accumulator circuit 819, e.g., via corresponding multiplexers 817A, . . . , 817N, 818A, . . . , 818M controlled by an appropriate value of the Mode signal. The accumulator circuit 819 accumulates the plurality of partial results (or the plurality of shifted partial results) using the second format (i.e., the TP numerical representation) to generate a complete result of the second format that is also stored in a register of the accumulator circuit 819. In a preferred embodiment, in order to minimize accumulation of an error, the accumulator circuit 819 accumulates the plurality of partial results from a smallest partial result among the plurality of partial results to a largest partial result among the plurality of partial results. Although FIG. 8 illustrates a single accumulator circuit 819, the multiplier circuitry in FIG. 8 may comprise a plurality of accumulator circuits, e.g., connected into a single accumulation stage or multiple accumulation stages. In one embodiment, the accumulator circuit 819 comprises at least 80 bits. In another embodiment, the accumulator circuit 819 comprises 96 bits. In yet another embodiment, the accumulator circuit 819 comprises 128 bits. However, the accumulator circuit 819 larger than 128 bits can also be utilized. In one example, when FP16 matrix multiplication operations utilize the accumulator circuit 819 for accumulations (e.g., within a matrix execution module) with the precision of, e.g., a 91-bit integer, a register of the accumulator circuit 819 is at least 116 bits wide because 22 compressed carry bits and three status bits are used for carry information to provide calculations using a faster clock frequency. Accumulated multiplier results are converted from the 116-bit register of the accumulator circuit 819 with 91-bit integer precision to FP32 using a truncation/conversion circuit 820 coupled to an output of the accumulator circuit 819. The truncation/conversion circuit 820 may cause truncation when the accumulated multiplier results are streamed from a matrix execution module to a vector execution module.

Because of a size of the accumulator circuit 819, no rounding (i.e., truncation) is applied during the accumulation in the accumulator circuit 819. The only rounding (i.e., truncation) is applied to a final accumulation result to obtain a final multiplication result of a desired floating point precision (e.g., FP16, FP32, FP64 precision, or some other floating point precision). In some implementations, significands of input operands are converted to integer format (e.g., at the conversion circuits 802, 803) enabling the multipliers 806A, . . . , 806N, 808A, . . . , 808M to perform a fused dot product operation instead of a fused multiply accumulate operation. The result of fused dot product operation is obtained and stored within the register of the accumulator circuit 819 to maintain a pre-defined precision, e.g., the precision of at least 80 bits. For example, when the multiplier circuitry of FIG. 8 is utilized as a building block in functional units of a language processing unit (e.g., in the M×M), up to 320 partial results of the fused dot product operation can be accumulated in the accumulator circuit 819 without any truncation. An accumulated result in the second format (e.g., TP format) stored in the register of the accumulator circuit 819 represents a complete multiplication result. The truncation/conversion circuit 820 coupled to the register of the accumulator circuit 819 converts the complete multiplication result of the second format (e.g., the TP number) into an output result of an output format that is stored in an output register 821. The truncation/conversion circuit 820 may convert the complete multiplication result from the second format into the output format by first selectively truncating a portion of the complete multiplication result stored in the register of the accumulator circuit 819. After the truncation, the truncation/conversion circuit 820 converts the complete multiplication result (i.e., the truncated accumulation result) into the output format, e.g., FP32 format, FP64 format, FP128 format, or some other floating point format. The conversion by the truncation/conversion circuit 820 may be based on a desired output precision provided to the truncation/conversion circuit 820 via an “Out_Format” signal, as shown in FIG. 8.

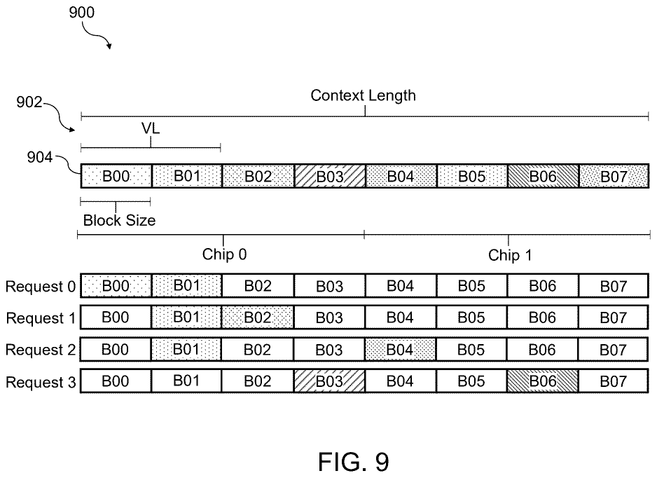

FIG. 9 depicts a diagram illustrating dynamic KV cache management with perceived non-determinism for a processor. FIG. 9 illustrates a KV cache 900 providing data vector 902 that is divided into a plurality of KV blocks 904, including, in the example of FIG. 9, eight KV blocks B00, B01, B02, B03, B04, B05, B06, and B07. The data vector 902 may have a context length. The context length can be greater than a vector length associated with the processor (e.g., the length of the maximum vector that may be stored and/or processed in a functional unit, such as V×M, M×M, etc.). Each KV block 904 may have a block size defined by a fixed number of tokens. The block size in the example of FIG. 9 is less than the vector length. For instance, in the example of FIG. 9, a vector length associated with the processor is equivalent to two KV blocks 904. A dynamic KV cache manager may identify and fetch separate KV blocks 904 for processing. In some examples, a processor system may be configured to multiply a query vector by key vectors in a KV block 904 to obtain an attention score and then later multiply the attention score by the value vectors in a KV block 904 to obtain an attention output.

Dynamically allocating portions of the context (e.g., dynamically allocating KV blocks in response to requests by a KV cache manager) may result in different accumulation ordering differences. For instance, partial results for different requests may be provided in one or more registers associated with a single vector in a single functional unit or group (e.g., partial results for two KV blocks 904 in the same vector 902), in registers associated with different vectors on a single processor, and/or in different registers across multiple different processors. In some cases, accumulation for partial results in different registers on a single processor may be accumulated in a V×M in a non-lossless numerical representation (e.g., floating point FP32). In some cases, accumulation for partial results in different registers across different processors may be accumulated in a V×M in a non-lossless numerical representation (e.g., floating point FP16). Accumulation order differences may lead to perceived non-determinism if a request gets a different allocation due to non-associativity of floating point numerical representations or other non-lossless numerical representations.

For instance, Request 0, Request 1, and Request 3 may be associated with the same input. In response to Request 0, a dynamic KV cache manager may identify and fetch KV blocks B00 and B01, which are within the same vector. Because blocks B00 and B01 are within the same vector, the blocks may be processed within the same functional unit and the results may be provided using a lossless numerical representation, such as an extended fixed-point numerical representation.

In response to Request 1, a dynamic KV cache manager may identify and fetch KV blocks B01 and B02. Because KV blocks B01 and B02 are provided as parts of different vectors on the same processor, the blocks of request 1 may be processed with a V×M configured for operating on different data vectors, which may provide for accumulation in a non-lossless numerical representation, such as FP32.

In response to Request 2, a dynamic KV cache manager may identify and fetch KV blocks B01 and B04. Because B01 and B04 are provided as parts of different vectors on different processors, the blocks of Request 2 may be processed with a V×M configured for operating on different data vectors on different processors, which may provide for accumulation in a non-lossless numerical representation, such as FP16.

Accordingly, due to possible accumulation order differences and different rounding/truncation precisions of the different V×Ms depending on the processor and vector locations of the different KV blocks 904, Requests 0, 1, and 2 may provide different results for the same input, leading to a perceived non-determinism. Similarly, due to the non-associative nature of non-lossless numerical representations, such as floating point numerical representations, different permutations of B03, B05, and B06 may give different results for the same input in Request 3.

According to example implementations of the present disclosure, accumulation differences may be reduced by using a cyclic distribution of KV blocks 904. More particularly, cyclically distributing elements of KV blocks 904 allows for accumulation of partial results within the same vector (or synchronized set of vectors), enabling the use of a lossless, associative numerical representation.

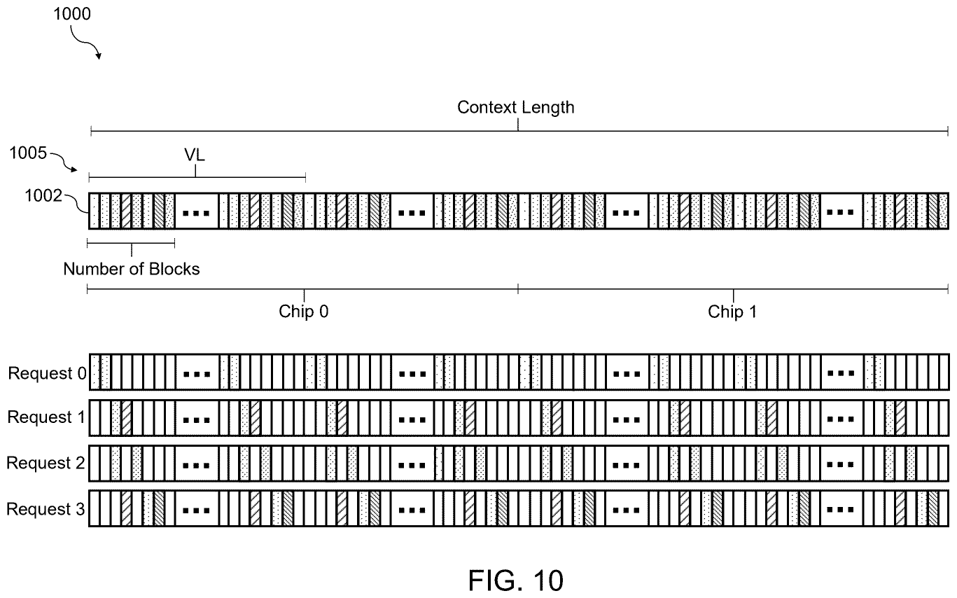

FIG. 10 depicts a diagram 1000 of an example cyclic distribution of KV blocks 904 according to example implementations of the present disclosure. The cross-hatching/shading of KV blocks 904 in FIG. 10 matches the cross-hatching/shading of elements of KV blocks 904 in FIG. 9. For instance, the cross-hatching of KV block B00 of FIG. 9 matches the cross-hatching/shading of elements of KV block B00 in FIG. 10.

As illustrated in FIG. 10, cyclic distribution of KV blocks 904 provides for a subset of elements 1002 of each of the plurality of KV blocks 904 to be associated with a single data vector 1005. The data vector 1005 can, for example, be key-value pairs associated with a token or token(s) output by a transformer model. The data vector 1005 may be stored in one or more registers of a processor, such as a language processing unit. The registers, for example, can be the input registers 321 of FIG. 3, the registers 400/401 of FIG. 4, and/or other similar registers, such as those incorporated into a vector execution module or matrix execution module. For instance, in some examples, the one or more registers may be one or more registers in a tensor processor, such as the tensor processor described in FIGS. 1-7. The operands, for example, may be tokens or other intermediate values (e.g., weights and activations) of a machine-learned model, and the elements 1002 of the KV blocks 904 that are assigned to correspond to the registers may store the key-value pairs associated with the operand in the KV cache. In this way, processing of the elements 1002 (e.g., multiplication and/or accumulation) may be implemented in a lossless numerical representation, such as an extended fixed-point representation, without relying on non-lossless numerical representations for processing of elements or KV blocks 904 across different vectors in the same processor or even across different processors.

For instance, as shown in FIG. 10 for Request 0, a first element of KV block B00 is provided with a first element of KV block B01 within the same vector with vector length VL on chip 0. A second element of KV block B00 is provided with a second element of KV block B01 within the same vector with vector length VL on chip 0. A functional element (e.g., M×M) may be used to process the elements and accumulate partial results in a lossless and associative numerical representation. Because the elements 1002 of disparate KV blocks are distributed in a cyclic configuration, the lossless and associative numerical representation can provide for consistent, deterministic processing of the data vector 1005 using floating point operations.

Similarly, a third element of KV block B00 is provided with a third element of KV block B01 in a second vector with vector length VL on chip 0. A fourth element of KV block B00 is provided with a fourth element of KV block B01 in a second vector with vector length VL on chip 0. A functional unit (e.g., M×M) may be used to process the elements and accumulate partial results in a lossless and associative numerical representation.

This pattern may continue across chip boundaries while maintaining deterministic accumulation. For instance, a fifth element of KV block B00 is provided with a fifth element of KV block B01 in a third vector with vector length VL on chip 1. A sixth element of KV block B00 is provided with a sixth element of KV block B01 in a third vector with vector length VL on chip 1. A functional unit (e.g., M×M) may be used to process the elements and accumulate partial results in a lossless and associative numerical representation. This pattern may continue with seventh elements, eighth elements, and so forth. FIG. 9 depicts a similar cyclic distribution of elements of KV blocks for Request 1, Request 2, and Request 3.

All partial results for the cyclic distribution of KV blocks may be accumulated in a lossless and associative numerical representation to provide an output for the request. Because the cyclic distribution provides for processing using lossless and associative numerical representations, there is reduced or eliminated perceived non-determinism for dynamic KV cache management, even when the elements 1002 of the KV blocks identified and fetched in response to the request are provided in one or more registers associated with the same vector, in a plurality of registers associated with different vectors on the same processor, or in a plurality of registers associated with different vectors on different processors.

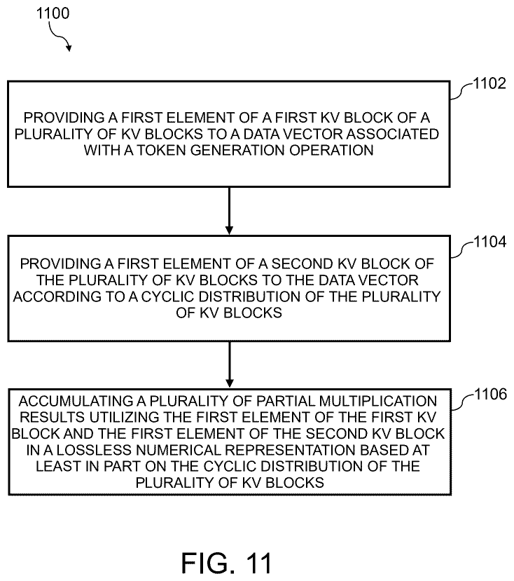

FIG. 11 depicts a flowchart of an example method 1100 for processing key-value (KV) blocks in a processor system according to example implementations of the present disclosure.

At 1102, the method 1100 includes providing a first element of a first KV block of a plurality of KV blocks to a data vector associated with a token generation operation. As described herein, an “element” of a KV block represents the granular unit of data within these blocks, such as the amount of memory utilized by the KV cache for data associated with a single token. In the context of a transformer model, this first element may correspond to a specific dimension of a key or value vector generated during a forward pass. The data vector serves as a container, such as a Single Instruction Multiple Data (SIMD) register or a set of synchronized registers, that holds these operands for processing by the functional units of the processor.

At 1104, the method 1100 includes providing a first element of a second KV block of the plurality of KV blocks to the data vector according to a cyclic distribution of the plurality of KV blocks. Unlike greedy allocation schemes that might fill a data vector with contiguous elements from the same block (e.g., [BlockA_0, BlockA_1]), the cyclic distribution actively interleaves elements from different blocks. For example, the system assigns elements in a cyclic ordering (e.g., Block A, then Block B, then Block C) such that the data vector contains a subset of elements from multiple different KV blocks simultaneously (e.g., [BlockA_0, BlockB_0]). This can provide that corresponding elements across blocks are aligned for the subsequent operation.

At 1106, the method 1100 includes accumulating a plurality of partial multiplication results utilizing the first element of the first KV block and the first element of the second KV block in a lossless numerical representation based at least in part on the cyclic distribution of the plurality of KV blocks. Because the cyclic distribution aligns these elements within the same vector operation or context, the system can utilize a lossless format, such as an extended fixed-point representation (e.g., TruePoint™), to sum the partial results. This lossless accumulation mitigates the non-associativity inherent in standard floating-point arithmetic, ensuring that the final output remains bitwise deterministic regardless of the physical non-contiguous locations of the dynamically allocated blocks.

In some implementations, the step of providing elements involves utilizing KV blocks associated with cached key-value vectors used to determine self-attention in a transformer model. The transformer model can utilize these cached vectors to avoid redundant computations when generating subsequent tokens in a sequence. By managing these blocks cyclically, the system maintains the high throughput required for Large Language Model (LLM) serving while preserving the reproducibility of the attention scores.

In some implementations, the data vector is associated with a plurality of registers of a functional unit of a tensor processor. These registers may be located within specific functional units, such as a Matrix Multiplication (M×M) unit or a Vector Matrix Multiplication (V×M) unit. The cyclic distribution provides that the registers are populated with interleaved data, allowing the functional unit to process the accumulation consistently across different user requests.

In some implementations, the method includes multiplying the first element of the first KV block with the first element of a second KV block to generate at least one first partial result. This operation can include, for example, a dot product calculation where a query vector is multiplied by the key vectors retrieved from the cyclic distribution to obtain a partial attention score. The system can generate these partial results locally before they are accumulated into the final score.

In some implementations, the method further includes multiplying a second element of the first KV block with a second element of the second KV block to generate at least one second partial result. This step provides for the iterative or parallel nature of the cyclic distribution, where subsequent elements (e.g., the second dimension of the key vectors) are fetched in a cyclic manner (e.g., [BlockA_1, BlockB_1]) and processed to generate additional partial results. This consistent stride provides that every dimension of the vector contributes to the accumulation in a deterministic order.

In some implementations, the registers holding these elements may be distributed across different hardware boundaries. For example, the first element of the first and second KV blocks may be provided in registers associated with a first vector, while the second elements are provided in registers associated with a second vector. These register sets may be located on a single processor or distributed across different processors. The cyclic distribution maintains the logical accumulation order even when the physical registers are spread across different lanes, functional groups, or chips.

In some implementations, the lossless numerical representation utilized is an extended fixed-point representation, such as a TruePoint™ numerical representation or extended fixed-point representation. This format allows partial results to be summed in any order based on dynamic availability without precision loss. By converting the floating-point operands into this lossless format for the accumulation stage, the system mitigates the rounding errors that can cause non-determinism in floating-point addition.

In some implementations, the processor can be or can include a language processing unit (LPU). The LPU can include a first plurality of functional units arranged in a first functional group and a second plurality of functional units arranged in a second functional group. In this architecture, data streams flow between functional groups in a first dimension (e.g., across lanes), while instructions flow within each functional group in a second dimension perpendicular to the first. The cyclic distribution can be beneficial in this architecture as the cyclic distribution can provide for aligning the data flow with the deterministic timing and execution model of the LPU.

In some implementations, the cyclic distribution comprises assigning elements of the plurality of KV blocks in sequentially increasing positions to new data vectors. This provides for the system to provide the data in a stripe configuration. For example, a first vector receives the first elements of Blocks A-D, a second vector receives the second elements of Blocks A-D, and so on. This ordered, sequential assignment pattern facilitates the predictable packing of registers and simplifies the logic required to reassemble the full attention scores during the accumulation phase.

Example aspects of the present disclosure are set forth below. Any of the below features or examples may be used in combination with any of the implementations or features provided in the present disclosure.

One example aspect of the present disclosure is directed to a computer-implemented method of performing floating point operations utilizing a plurality of key-value (KV) blocks of a KV cache in a processor. The method includes providing a first element of a first KV block of the plurality of KV blocks to a data vector associated with a token generation operation. The method further includes providing a first element of a second KV block of the plurality of KV blocks to the data vector according to a cyclic distribution of the plurality of KV blocks. The method also includes accumulating a plurality of partial multiplication results utilizing the first element of the first KV block and the first element of the second KV block in a lossless numerical representation based at least in part on the cyclic distribution of the plurality of KV blocks.

In some implementations, the plurality of KV blocks are associated with cached key-value vectors used to determine self-attention in a transformer model.

In some implementations, the data vector is associated with a plurality of registers of a functional unit of a tensor processor.

In some implementations, the method further comprises multiplying the first element of the first KV block with the first element of a second KV block to generate at least one first partial result of the plurality of partial results.

In some implementations, the method further comprises multiplying a second element of the first KV block with a second element of the second KV block to generate at least one second partial result of the plurality of partial results.

In some implementations, the first element of the first KV block and the first element of the second KV block are provided in one or more first registers associated with a first data vector and the second element of the first KV block and the second element of the second KV block are provided in one or more second registers associated with a second data vector.

In some implementations, the one or more first registers and the one or more second registers are located on a single processor.

In some implementations, the one or more first registers and the one or more second registers are located on different processors.

In some implementations, the lossless numerical representation is an extended fixed-point representation.

In some implementations, the processor comprises a language processing unit.

In some implementations, the language processing unit comprises a first plurality of functional units arranged in a first functional group and a second plurality of functional units arranged in a second functional group, wherein a data stream flows between the first functional group and the second functional group in a first dimension and instructions flow in each of the first functional group and the second functional group in a second dimension, the second dimension being perpendicular to the first dimension.

In some implementations, the cyclic distribution comprises assigning elements of the plurality of KV blocks in sequentially increasing positions to new data vectors.

Another example aspect of the present disclosure is directed to a processor configured to perform operations. The operations include providing a first element of a first KV block of a plurality of KV blocks to a data vector associated with a token generation operation. The operations further include providing a first element of a second KV block of the plurality of KV blocks to the data vector according to a cyclic distribution of the plurality of KV blocks. The operations also include accumulating a plurality of partial multiplication results utilizing the first element of the first KV block and the first element of the second KV block in a lossless numerical representation based at least in part on the cyclic distribution of the plurality of KV blocks.

In some implementations, the plurality of KV blocks are associated with cached key-value vectors used to determine self-attention in a transformer model.

In some implementations, the data vector is associated with a plurality of registers of a functional unit of a tensor processor.

In some implementations, the processor is further configured to multiply the first element of the first KV block with the first element of a second KV block to generate at least one first partial result of the plurality of partial results.

In some implementations, the processor is further configured to multiply a second element of the first KV block with a second element of the second KV block to generate at least one second partial result of the plurality of partial results.

In some implementations, the first element of the first KV block and the first element of the second KV block are provided in one or more first registers associated with a first data vector and the second element of the first KV block and the second element of the second KV block are provided in one or more second registers associated with a second data vector.

In some implementations, the processor comprises a language processing unit, wherein the language processing unit comprises a first plurality of functional units arranged in a first functional group and a second plurality of functional units arranged in a second functional group, wherein a data stream flows between the first functional group and the second functional group in a first dimension and instructions flow in each of the first functional group and the second functional group in a second dimension, the second dimension being perpendicular to the first dimension.

Yet another example aspect of the present disclosure is directed to one or more non-transitory computer-readable media storing instructions that, when executed, cause a processor device to perform operations. The operations include providing a first element of a first KV block of a plurality of KV blocks to a data vector associated with a token generation operation. The operations further include providing a first element of a second KV block of the plurality of KV blocks to the data vector according to a cyclic distribution of the plurality of KV blocks. The operations also include accumulating a plurality of partial multiplication results utilizing the first element of the first KV block and the first element of the second KV block in a lossless numerical representation based at least in part on the cyclic distribution of the plurality of KV blocks.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of performing floating point operations utilizing a plurality of key-value (KV) blocks of a KV cache in a processor, comprising:
providing a first element of a first KV block of the plurality of KV blocks to a data vector associated with a token generation operation;
providing a first element of a second KV block of the plurality of KV blocks to the data vector according to a cyclic distribution of the plurality of KV blocks; and
accumulating a plurality of partial multiplication results utilizing the first element of the first KV block and the first element of the second KV block in a lossless numerical representation based at least in part on the cyclic distribution of the plurality of KV blocks.

2. The method of claim 1, wherein the plurality of KV blocks are associated with cached key-value vectors used to determine self-attention in a transformer model.

3. The method of claim 1, wherein the data vector is associated with a plurality of registers of a functional unit of a tensor processor.

4. The method of claim 1, further comprising multiplying the first element of the first KV block with the first element of the second KV block to generate at least one first partial result of the plurality of partial results.

5. The method of claim 4, further comprising multiplying a second element of the first KV block with a second element of the second KV block to generate at least one second partial result of the plurality of partial results.

6. The method of claim 5, wherein the first element of the first KV block and the first element of the second KV block are provided in one or more first registers associated with a first data vector and the second element of the first KV block and the second element of the second KV block are provided in one or more second registers associated with a second data vector.

7. The method of claim 6, wherein the one or more first registers and the one or more second registers are located on a single processor.

8. The method of claim 6, wherein the one or more first registers and the one or more second registers are located on different processors.

9. The method of claim 1, wherein the lossless numerical representation is an extended fixed-point representation.

10. The method of claim 1, wherein the processor comprises a language processing unit.

11. The method of claim 10, wherein the language processing unit comprises a first plurality of functional units arranged in a first functional group and a second plurality of functional units arranged in a second functional group, wherein a data stream flows between the first functional group and the second functional group in a first dimension and instructions flow in each of the first functional group and the second functional group in a second dimension, the second dimension being perpendicular to the first dimension.

12. The method of claim 1, wherein the cyclic distribution comprises assigning elements of the plurality of KV blocks in sequentially increasing positions to new data vectors.

13. A processor configured to:
provide a first element of a first KV block of a plurality of KV blocks to a data vector associated with a token generation operation;
provide a first element of a second KV block of the plurality of KV blocks to the data vector according to a cyclic distribution of the plurality of KV blocks; and
accumulate a plurality of partial multiplication results utilizing the first element of the first KV block and the first element of the second KV block in a lossless numerical representation based at least in part on the cyclic distribution of the plurality of KV blocks.

14. The processor of claim 13, wherein the plurality of KV blocks are associated with cached key-value vectors used to determine self-attention in a transformer model.

15. The processor of claim 13, wherein the data vector is associated with a plurality of registers of a functional unit of a tensor processor.

16. The processor of claim 13, further comprising multiplying the first element of the first KV block with the first element of the second KV block to generate at least one first partial result of the plurality of partial results.

17. The processor of claim 16, further comprising multiplying a second element of the first KV block with a second element of the second KV block to generate at least one second partial result of the plurality of partial results.

18. The processor of claim 17, wherein the first element of the first KV block and the first element of the second KV block are provided in one or more first registers associated with a first data vector and the second element of the first KV block and the second element of the second KV block are provided in one or more second registers associated with a second data vector.

19. The processor of claim 13, wherein the processor comprises a language processing unit, wherein the language processing unit comprises a first plurality of functional units arranged in a first functional group and a second plurality of functional units arranged in a second functional group, wherein a data stream flows between the first functional group and the second functional group in a first dimension and instructions flow in each of the first functional group and the second functional group in a second dimension, the second dimension being perpendicular to the first dimension.

20. One or more non-transitory, computer-readable media storing instructions that, when executed, cause a processor device to perform operations comprising:
providing a first element of a first KV block of a plurality of KV blocks to a data vector associated with a token generation operation;
providing a first element of a second KV block of the plurality of KV blocks to the data vector according to a cyclic distribution of the plurality of KV blocks; and
accumulating a plurality of partial multiplication results utilizing the first element of the first KV block and the first element of the second KV block in a lossless numerical representation based at least in part on the cyclic distribution of the plurality of KV blocks.
